(19) United States
(12) Patent Application Publication
(10) Pub. No.: US 2024/0282253 A1
(43) Pub. Date: Aug. 22, 2024

(54) DISPLAY DEVICE

(71) Applicant: Sony Semiconductor Solutions Corporation, Kanagawa (JP)

(72) Inventors: Seiya Matsuo, Fukuoka (JP); Yuyang Jiang, Fukuoka (JP)

(21) Appl. No.: 18/570,512

(22) PCT Filed: Jun. 7, 2022
(86) PCT No.: PCT/JP22/23012

§ 371 Date: Dec. 14, 2023

(30) Foreign Application Priority Data
Jun. 21, 2021 (JP) 2021-102674

(51) Int. Cl. G09G 3/3208

(52) U.S. Cl. CPC G09G 3/3208; G09G 2310/0294; G09G 2310/066; G09G 2320/0233; G09G 2320/043; G09G 2330/028

(57) ABSTRACT

Display devices that retain display quality under ramp wave voltage pixel driving are disclosed. In one example, a display device includes signal lines that supply signal voltages corresponding to gradation to pixel circuits. An error amplifier outputs an instruction signal corresponding to a difference between first and second ramp wave voltages. The second ramp wave voltage is output in response to the instruction signal. Voltage holding units hold the second ramp wave voltage and generate the signal voltages at a timing according to luminance of the pixel circuits by switches connected between ramp wiring and the signal lines. Correction current sources supply a correction current to connection paths between the ramp wiring and the voltage holding units, and a current adjustment unit adjusts the correction current on the basis of the instruction signal.

### TECHNICAL FIELD

The present disclosure relates to a display device.

### BACKGROUND ART

There is an increasing demand for image quality of organic electroluminescence (EL) devices and liquid crystal display devices, and various kinds of measures for improving image quality have been made. For example, since the organic EL devices use self-luminous elements, the organic EL devices are superior in contrast to the liquid crystal display devices. However, in a case where an image having significantly different luminance is displayed on the same horizontal line of the display screen, there is a possibility that the image is displayed with brightness different from original luminance under the influence of adjacent pixels. (see Patent Document 1).

### CITATION LIST

### Patent Document

Patent Document 1: Japanese Patent Application Laid-Open No. 2004-133240

### SUMMARY OF THE INVENTION

### Problems to be Solved by the Invention

For example, in a case where an image having significantly different luminance is displayed between a part of the pixel region on the left end side or the right end side of the display screen and the remaining pixel region, only the part of the pixel region is displayed with brightness different from original luminance, and a streak may be visually recognized at a boundary portion of the part of the display region.

This phenomenon can be reduced by adjusting the voltage at one end portion of the ramp wiring, but further improvement in adjustment accuracy and adjustment speed is required.

Therefore, the present disclosure provides a display device capable of improving display quality in a case where pixel driving is performed using a ramp wave voltage.

### Solutions to Problems

In order to solve the above problem, according to the present disclosure, there is provided a display device including:
a plurality of pixel circuits arranged in at least one direction;
a plurality of signal lines that supplies a signal voltage corresponding to gradation to the plurality of pixel circuits;
an error amplifier that outputs an instruction signal corresponding to a difference between a first ramp wave voltage whose voltage level changes with time and a second ramp wave voltage that is a predetermined potential of a ramp wiring;
an output unit that outputs the second ramp wave voltage based on the first ramp wave voltage to the ramp wiring in response to the instruction signal;
a plurality of voltage holding units that holds the second ramp wave voltage and generates the signal voltage at a timing according to luminance of the plurality of pixel circuits by switches connected between the ramp wiring and the plurality of signal lines;
a plurality of correction current sources that supplies a correction current to a plurality of connection paths between the ramp wiring and the plurality of voltage holding units; and
a current adjustment unit that adjusts the correction current on the basis of the instruction signal.

When the second ramp wave voltage is supplied to the ramp wiring, the plurality of correction current sources may supply the correction current being same to the plurality of connection paths regardless of luminance set to the plurality of pixel circuits.

The current adjustment unit may adjust the correction current such that the instruction signal in a case where the correction current flows from the plurality of correction current sources to the plurality of connection paths coincides with the instruction signal in a case where the correction current does not flow.

The current adjustment unit may adjust the correction current on the basis of a difference between a first instruction signal output from the error amplifier in a case where the plurality of connection paths is in a first state and a second instruction signal output from the error amplifier in a case where the plurality of connection paths is in a second state different from the first state.

The current adjustment unit may adjust the correction current such that a voltage based on the first instruction signal matches a voltage based on the second instruction signal.

A voltage based on the first instruction signal and a voltage based on the second instruction signal may be correlated with a current value flowing through a predetermined portion of the ramp wiring in the first state and a current value flowing through a predetermined portion of the ramp wiring in the second state.

The plurality of pixel circuits in the first state may have white luminance, and the plurality of pixel circuits in the second state may have black luminance.

The first instruction signal may be the instruction signal in a case where the correction current flows from the plurality of correction current sources to the plurality of connection paths, and the second instruction signal may be the instruction signal in a case where the correction current does not flow.

The current adjustment unit may perform processing of making the correction current larger in a case where a voltage based on the second instruction signal is lower than a voltage based on the first instruction signal, and making the correction current smaller in a case where the voltage based on the second instruction signal is higher than the voltage based on the first instruction signal.

The current adjustment unit may include:
a voltage comparator that outputs a signal corresponding to a voltage difference between a voltage based on the first instruction signal and a voltage based on the second instruction signal; and
an adjustment signal generation unit that generates an adjustment signal of a plurality of bits for the current adjustment unit to adjust the correction current on the basis of the signal output from the voltage comparator, and
the current adjustment unit may adjust the correction current on the basis of the adjustment signal.

The adjustment signal generation unit may adjust the adjustment signal by one bit each time the correction current is adjusted.

The current adjustment unit may further include
a current-voltage conversion unit that converts a voltage into the voltage based on the first instruction signal and the voltage based on the second instruction signal.

The voltage based on the first instruction signal and the voltage based on the second instruction signal may be correlated with a current value flowing through a predetermined portion of the ramp wiring.

The voltage comparator may be any of a successive approximation type analog-to-digital converter, a pipeline analog-to-digital converter, a comparator, and an error amplifier.

The current adjustment unit may further include a bias circuit that generates a bias potential according to the adjustment signal and supplies the bias potential to the correction current source, and
the correction current source may output the correction current according to the bias potential.

The bias circuit may include a capacitor.

The current adjustment unit may include:
a voltage comparator that outputs a signal corresponding to a voltage difference between a voltage based on the first instruction signal and a voltage based on the second instruction signal;
a phase comparator that outputs a signal corresponding to a phase difference between the signal output from the voltage comparator and a predetermined reference signal; and
a charge pump that outputs a voltage corresponding to a signal output from the phase comparator, and
the current adjustment unit may adjust the correction current on the basis of a voltage output from the charge pump.

The output unit may output an offset voltage for correcting characteristic variations of the plurality of pixel circuits to the ramp wiring before outputting the second ramp wave voltage to the ramp wiring, and
the current adjustment unit may adjust the correction current supplied from the plurality of correction current sources to the plurality of connection paths on the basis of a difference between the instruction signals when outputting the second ramp wave voltage.

The current adjustment unit may adjust the correction current a plurality of times, one time each in accordance with horizontal line scanning, within a blanking period between two consecutive frames.

The voltage level of the first ramp wave voltage may fluctuate linearly with time.

### BRIEF DESCRIPTION OF DRAWINGS

FIG. 1 is a block diagram illustrating a schematic configuration of a display system 2 including a display device according to a first embodiment.

FIG. 2 is a circuit diagram illustrating an internal configuration of a pixel circuit.

FIG. 3 is a circuit diagram illustrating another internal configuration of the pixel circuit.

FIG. 4A is a block diagram illustrating an internal configuration of an H-DRV unit.

FIG. 4B is a diagram illustrating a configuration example of a plurality of correction current sources.

FIG. 5 is an equivalent circuit diagram in a case where three voltage holding units are connected to a ramp wiring.

FIG. 6 is a diagram illustrating an example of horizontal crosstalk.

FIG. 7A is a diagram schematically illustrating operation by a current adjustment unit.

FIG. 7B is a diagram schematically illustrating voltage levels of connection paths with each of voltage holding units on the ramp wiring.

FIG. 8 is a diagram schematically illustrating operation by a current adjustment unit.

FIG. 9 is a block diagram illustrating a schematic configuration of a current adjustment unit according to the present embodiment.

FIG. 10 is a time chart illustrating a processing operation of the current adjustment unit in FIG. 9.

FIG. 11 is a flowchart illustrating a processing operation of the current adjustment unit in FIG. 9.

FIG. 12 is a block diagram illustrating a configuration example of a current adjustment unit according to Modification 1 of the first embodiment.

FIG. 13 is a time chart illustrating a processing operation of the current adjustment unit in FIG. 12.

FIG. 14 is a block diagram illustrating a configuration example of a current adjustment unit according to Modification 2 of the first embodiment.

FIG. 15 is a time chart illustrating a processing operation of the current adjustment unit in FIG. 14.

FIG. 16 is a block diagram illustrating a configuration example of a current adjustment unit according to Modification 3 of the first embodiment.

FIG. 17 is a flowchart illustrating a processing operation of the current adjustment unit in FIG. 16.

FIG. 18 is a block diagram illustrating a configuration example of a current adjustment unit according to Modification 4 of the first embodiment.

FIG. 19 is a block diagram illustrating a configuration example of a current adjustment unit according to Modification 5 of the first embodiment.

FIG. 20 is a block diagram illustrating a configuration example of a current adjustment unit according to Modification 6 of the first embodiment.

FIG. 21 is a time chart illustrating a processing operation of the current adjustment unit in FIG. 20.

FIG. 22 is a block diagram illustrating a configuration example of a current adjustment unit according to Modification 7 of the first embodiment.

FIG. 23 is a block diagram illustrating a configuration example of a current adjustment unit according to Modification 8 of the first embodiment.

FIG. 24 is a flowchart illustrating a processing operation of the current adjustment unit in FIG. 23.

FIG. 25 is a block diagram illustrating a configuration example of a current adjustment unit according to Modification 9 of the first embodiment.

FIG. 26 is a time chart illustrating a processing operation of the current adjustment unit in FIG. 25.

FIG. 27 is a diagram illustrating a configuration example of a pixel PIX.

FIG. 28 is a diagram illustrating another configuration example of a pixel PIX.

FIG. 29 is a diagram illustrating another configuration example of a pixel PIX.

FIG. 30 is a diagram illustrating another configuration example of a pixel PIX.

FIG. 31 is a diagram illustrating another configuration example of a pixel PIX.

FIG. 32 is a diagram illustrating another configuration example of a pixel PIX.

FIG. 33 is a diagram illustrating another configuration example of a pixel PIX.

FIG. 34 is a diagram illustrating an example of an external appearance of a head mounted display.

FIG. 35 is a diagram illustrating an example of an external appearance of another head mounted display.

FIG. 36 is a front view illustrating an example of an external appearance of a digital still camera.

FIG. 37 is a side view illustrating an example of an external appearance of a digital still camera.

FIG. 38 is a diagram illustrating an example of an external appearance of a television device.

FIG. 39 is a diagram illustrating an example of an external appearance of a smartphone.

FIG. 40 is a diagram illustrating a configuration example of a vehicle and an example of the inside of the vehicle as viewed from the rear of the vehicle.

FIG. 41 is a diagram illustrating a configuration example of a vehicle and an example of the inside of the vehicle as viewed from the left rear of the vehicle.

### MODE FOR CARRYING OUT THE INVENTION

Hereinafter, embodiments of a display device will be described with reference to the drawings. Although main components of the display device will be mainly described below, the display device may have a component or function that is not illustrated or described. The following description does not exclude components and functions that are not illustrated or described.

### First Embodiment

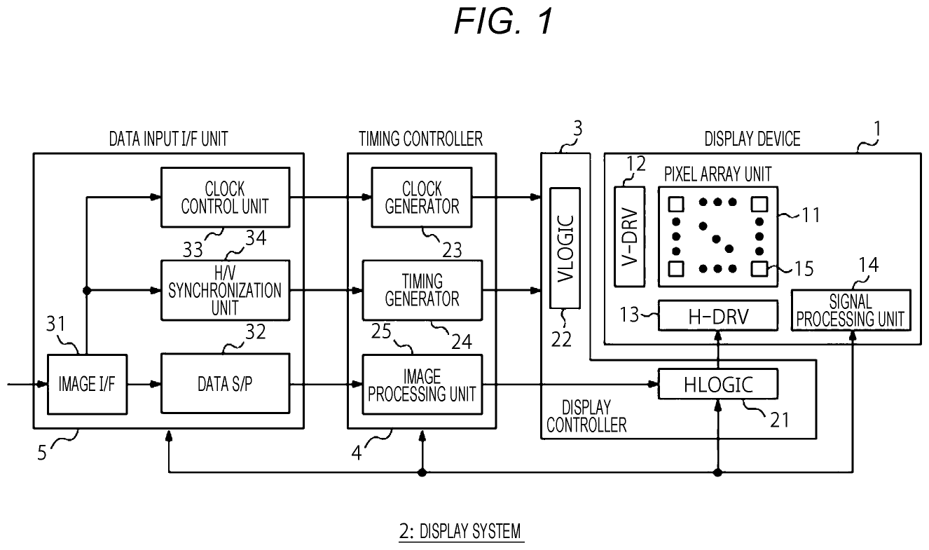

FIG. 1 is a block diagram illustrating a schematic configuration of a display system 2 including a display device 1 according to a first embodiment. The display system 2 in FIG. 1 illustrates a configuration of a micro organic light emitting diode (OLED) system. Note that the display device 1 according to the present embodiment is also applicable to the display system 2 including a display device 1 having a large screen, such as a TV or a PC monitor.

The display system 2 in FIG. 1 includes the display device 1, a display controller 3, timing controller 4, and a data input/output I/F unit 5. Note that, although the display controller 3 and the like are separated from the display device 1 in FIG. 1, a display controller or the like may be integrated into the display device 1.

The display device 1 has a pixel array unit 11, a V-DRV unit 12, an H-DRV unit 13, and a signal processing unit 14.

The pixel array unit 11 has a plurality of pixel circuits 15 arranged in a horizontal direction and a vertical direction. Each of the pixel circuits 15 has, for example, a light emission unit such as an organic EL element, a plurality of transistors that controls the light emission unit, and a plurality of capacitances. An internal configuration of the pixel circuit 15 will be described later.

The signal processing unit 14 performs signal processing of a video signal to be displayed on the pixel array unit 11. The specific content of the signal processing is not limited, and is, for example, gamma correction or the like. The video signal subjected to the signal processing by the signal processing unit 14 is transmitted to the H-DRV unit 13.

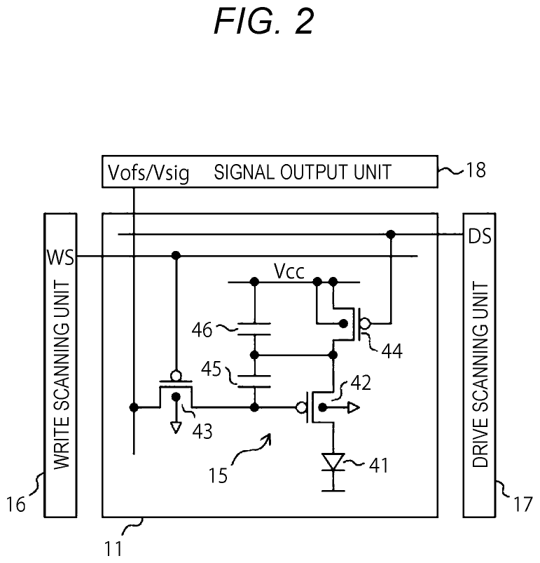

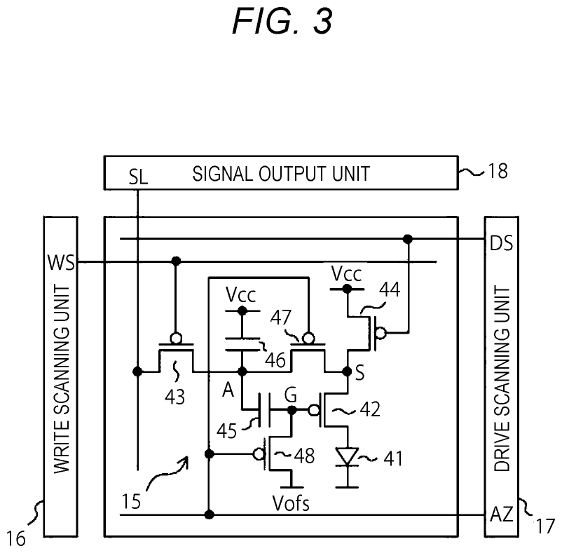

As illustrated in FIGS. 2 and 3 to be described later, the V-DRV unit 12 includes a write scanning unit 16 and a drive scanning unit 17. When writing a signal voltage to each of the pixel circuits 15, the write scanning unit 16 sequentially supplies a write scanning signal to each scanning line to sequentially drive each of scanning lines WS1 to WSn. The drive scanning unit 17 supplies a light emission control signal to each drive line in synchronization with the line-sequential scanning by the write scanning unit 16, and controls light emission and non-light emission of the light emission unit.

The H-DRV unit 13 includes a signal output unit 18 as illustrated in FIGS. 2 and 3. The signal output unit 18 holds a ramp wave voltage at a timing corresponding to gradation of each pixel to generate a signal voltage. The signal output unit 18 selectively selects the signal voltage or an offset voltage Vofs and supplies the signal voltage or the offset voltage Vofs to a corresponding signal line. The offset voltage Vofs is a voltage serving as a reference of a signal voltage (for example, a voltage corresponding to a black level of a video signal), and is used to perform threshold correction operation to be described later.

The signal voltage or offset voltage Vofs alternatively output from the signal output unit 18 is supplied to each of the pixel circuits 15 via the signal line, and is set in each of the pixel circuits 15 in units of rows selected by scanning by the write scanning unit 16.

The display controller 3 includes an HLOGIC unit 21 and a VLOGIC unit 22, and performs display control on the pixel array unit 11.

The HLOGIC unit 21 supplies the video signal to the H-DRV unit 13. The VLOGIC unit 22 supplies a signal that specifies timings of a scanning line and a drive line to the V-DRV unit 12.

The timing controller 4 includes a clock generator 23, a timing generator 24, and an image processing unit 25. The clock generator 23 generates a vertical synchronization clock and a horizontal synchronization clock of the display device 1, and supplies a vertical synchronization clock and a horizontal synchronization clock to the display controller 3. The timing generator 24 generates a signal that specifies an operation timing of the display controller 3 and supplies the signal to the display controller 3. The image processing unit 25 performs various kinds of image processing on the video signal input to the data input/output I/F unit 5. The video signal subjected to the image processing is supplied to the HLOGIC unit 21 in the display controller 3.

The data input/output I/F unit 5 includes an image I/F unit 31, a data S/P unit 32, a clock control unit 33, and an H/V synchronization unit 34. The image I/F unit 31 receives a video signal from an outside. The video signal is serial digital data. The data S/P unit 32 converts the video signal into parallel data, and then transmits the parallel data to the image processing unit 25 in the timing controller 4. The clock control unit 33 generates a clock that suits display frequency of the display device 1. The H/V synchronization unit 34 generates a signal that specifies the horizontal synchronization timing and vertical synchronization timing of the display device 1, and transmits the signal to the timing generator 24.

FIG. 2 is a circuit diagram illustrating an internal configuration of the pixel circuits 15. The pixel circuit 15 in FIG. 2 includes a light emission unit 41 having an organic EL element, a drive transistor 42, a sampling transistor 43, a light emission control transistor 44, a holding capacitance 45, and an auxiliary capacitance 46. The pixel circuit 15 is formed on a semiconductor substrate such as silicon, and the drive transistor 42, the sampling transistor 43, and the light emission control transistor 44 are, for example, PMOS transistors. A power supply voltage is applied to a back gate of each of the transistors.

The sampling transistor 43 samples a signal voltage Vsig supplied from the signal output unit 18 via the signal line to write the signal voltage Vsig to the holding capacitance 45. The light emission control transistor 44 is connected between a power supply node of a power supply voltage Vcc and a source electrode of the drive transistor 42, and controls light emission/non-light emission of the light emission unit 41 under driving by the light emission control signal DS.

The holding capacitance 45 is connected between a gate electrode and source electrode of the drive transistor 42. The holding capacitance 45 holds the signal voltage Vsig written by sampling by the sampling transistor 43. The drive transistor 42 drives the light emission unit 41 by passing a drive current corresponding to holding voltage of the holding capacitance 45 through the light emission unit 41. The auxiliary capacitance 46 is connected between the source electrode of the drive transistor 42 and a node at a fixed potential, for example, the power supply node of a power supply voltage Vcc. The auxiliary capacitance 46 reduces fluctuation in source potential of the drive transistor 42 when the signal voltage Vsig is written, and performs an action of matching a gate-source voltage Vgs of the drive transistor 42 with a threshold voltage Vth of the drive transistor 42.

The internal configuration of the pixel circuit 15 is not limited to that illustrated in FIG. 2. For example, FIG. 3 is a circuit diagram of a pixel circuit 15 having an internal configuration different from that of FIG. 2. The light emission control transistor 44 is connected between the power supply potential Vcc and the source S of the drive transistor 42, and controls on/off of the light emission unit 41. A gate of the light emission control transistor 44 is connected to a scanning line DS.

The sampling transistor 43 is connected between a signal line SL and a connection node A of the holding capacitance 45 and auxiliary capacitance 46. A gate of the sampling transistor 43 is connected to a scanning line WS. A detection transistor 47 is connected between the connection node A and the source S of the drive transistor 42. A gate of the detection transistor 47 is connected to a scanning line AZ. A switching transistor 48 is connected between a gate G of the drive transistor 42 and a predetermined offset potential Vofs. A gate of the switching transistor 48 is connected to the scanning line AZ. The detection transistor 47 and the switching transistor 48 constitute a correction means for Vth cancellation. The holding capacitance 45 is connected between the connection node A and the gate G of the drive transistor 42, and the auxiliary capacitance 46 is connected between the power supply potential Vcc and the connection node A.

The drive transistor 42 drives the light emission unit 41 by passing a drain current Ids between a source and a drain according to a gate voltage Vgs applied between the source and the gate. The gate voltage Vgs of the drive transistor 42 is set according to a video signal Vsig supplied from the signal line SL, and luminance of light emitted from the light emission unit 41 can be controlled according to a gradation of the video signal by the drain current Ids of the drive transistor 42.

The threshold voltage Vth of the drive transistor 42 fluctuates for each pixel. In order to cancel the threshold voltage, the threshold voltage Vth of the drive transistor 42 is detected in advance and held in the holding capacitance 45. Thereafter, the sampling transistor 43 is turned on, and a signal potential Vsig is written to the auxiliary capacitance 46. With this arrangement, a gate potential Vgs in which a variation in the threshold voltage Vth of the drive transistor 42 is corrected is generated.

FIGS. 2 and 3 are examples of the pixel circuit 15, and a pixel circuit 15 having an internal configuration other than FIGS. 2 and 3 can also be applied to the pixel circuit 15 according to the present embodiment.

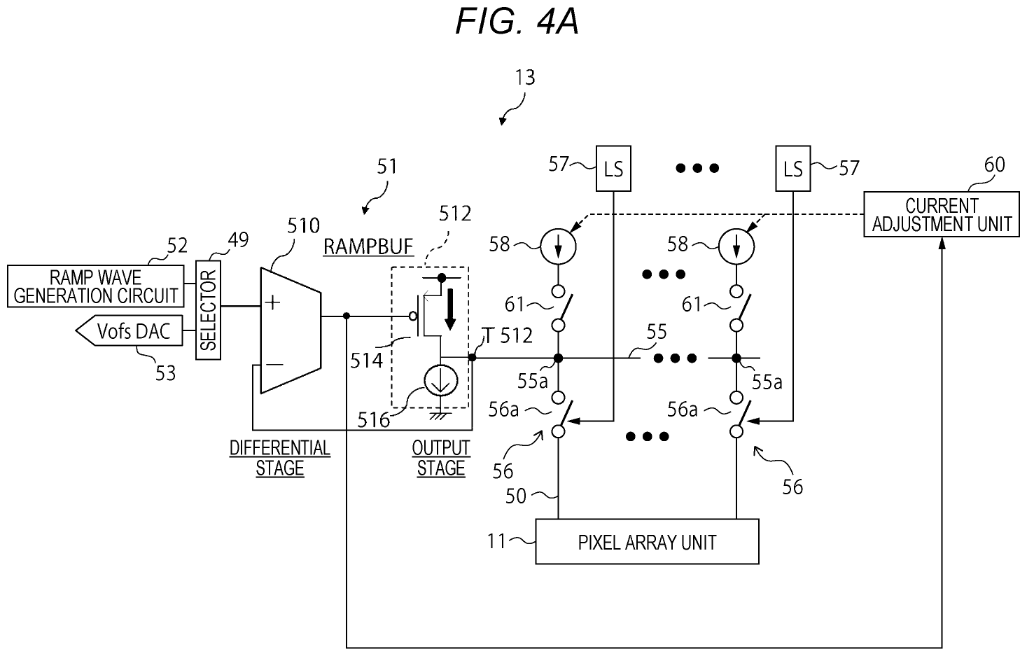

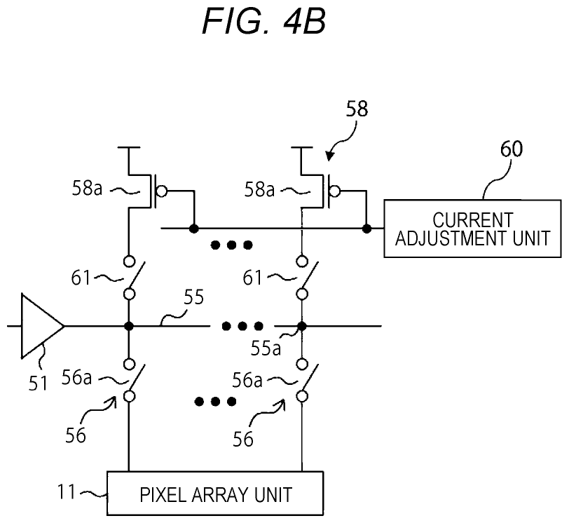

FIG. 4A is a block diagram illustrating an internal configuration of the H-DRV unit 13. The H-DRV unit 13 includes a selector 49, a ramp buffer (RAMBUF) 51, a ramp wave generation circuit 52, a Vofs DAC 53, a ramp wiring 55, a plurality of voltage holding units 56, a plurality of level shifters (LS) 57, a plurality of correction current sources 58, and a current adjustment unit 60.

The ramp buffer 51 switches one of an offset voltage for performing threshold correction and mobility correction of the drive transistor 42 in the pixel circuit 15 and a first ramp wave voltage whose voltage level continuously changes by the selector 49, then buffers the one of the offset voltage and the first ramp wave voltage, and outputs the buffered one to the ramp wiring 55.

The ramp buffer 51 includes a differential stage 510 and an output unit 512. Note that details of the ramp buffer 51 will be described later.

The ramp wave generation circuit 52 generates a first ramp wave voltage whose voltage level changes with time. The Vofs DAC 53 generates an offset voltage for performing threshold correction and mobility correction.

The plurality of voltage holding units 56 and a plurality of switches 61 are connected to the ramp wiring 55. At a time when the ramp wave voltage becomes a voltage corresponding to gradation of the pixel circuit 15, the plurality of voltage holding units 56 holds the voltage. The held voltage is a signal voltage and is supplied to a signal line 50.

Each voltage holding unit 56 includes a switch 56a. Each switch 56a in the each of the voltage holding units 56 is turned on or off according to output voltage of a corresponding level shifter 57. A PWM signal corresponding to gradation data of each pixel is input to the level shifter 57.

The plurality of correction current sources 58 supplies a correction current to a plurality of connection paths 55a between the ramp wiring 55 and the plurality of voltage holding units 56. When supplying the second ramp wave voltage to the ramp wiring 55 via a terminal T512, the plurality of correction current sources 58 supplies the same correction current to the plurality of connection paths 55a regardless of the luminance set in the plurality of pixel circuits 15.

The plurality of switches 61 is provided between the plurality of correction current sources 58 and the plurality of connection paths 55a. These switches 61 can be turned on or off individually.

Here, details of the ramp buffer 51 will be described. The differential stage 510 outputs an instruction signal corresponding to a difference between the first ramp wave voltage generated by the ramp wave generation circuit 52 and the second ramp wave voltage that is a predetermined voltage in the ramp wiring 55.

For example, the differential stage 510 outputs a difference between the first ramp wave voltage and the second ramp wave voltage as an instruction signal corresponding to the gain magnification Gm. Note that, for example, the differential stage 510 may be constructed with an error amplifier.

The output unit 512 includes a common-source transistor 514 and a current source 516. The common-source transistor 514 has a voltage source connected to a drain, and drives the current source 516 according to an instruction signal. As a result, the second ramp wave voltage corresponding to the first ramp wave voltage generated by the ramp wave generation circuit 52 is supplied from the output terminal T512 of the output unit 512. As can be seen from these, the ramp buffer 51 acts such that the second ramp wave voltage supplied from the terminal T512 matches the first ramp wave voltage.

The current adjustment unit 60 can adjust the correction current flowing from the plurality of correction current sources 58 on the basis of the instruction signal of the differential stage 510. The current adjustment unit 60 adjusts the correction current on the basis of a difference between the instruction signal of the differential stage 510 in a case where the plurality of connection paths 55a is in the first state and the instruction signal of the differential stage 510 in a case where the plurality of connection paths 55a is in the second state different from the first state.

The first state is, for example, a state in which all the switches 56a are turned on and all the switches 61 are turned off. The first luminance is, for example, white luminance and corresponds to a white gradation writing state.

The second state is, for example, a state in which all the switches 56a are turned off and all the switches 61 are turned on. The second luminance is, for example, black luminance and corresponds to the black gradation writing state.

More specifically, the current adjustment unit 60 adjusts the correction current on the basis of the difference between the instruction signals of the differential stage 510 in a case where all the switches 56a are turned on and all the switches 61 are turned off and in a case where all the switches 56a are turned off and all the switches 61 are turned on so as to match the charge/discharge current to the pixel. That is, the current adjustment unit 60 adjusts the correction current so that the fluctuation of the instruction signal within a predetermined time is equivalent between the case where all the switches 56a are turned on and all the switches 61 are turned off and the case where all the switches 56a are turned off and all the switches 61 are turned on. In this case, the fluctuation per unit time of the difference voltage between the second ramp wave voltage and the first ramp wave voltage supplied from the terminal T512 changes equivalently between the case where the correction current flows through the plurality of connection paths 55a and the case where the correction current does not flow through the plurality of connection paths 55a. On the basis of the instruction signal of the differential stage 510, the current adjustment unit 60 may adjust the correction current a plurality of times one by one in accordance with the scanning of the horizontal line within the blanking period between two consecutive frames.

FIG. 4B is a diagram illustrating a configuration example of the plurality of correction current sources 58. The plurality of correction current sources 58 includes a plurality of PMOS transistors 58a that controls a correction current according to the bias voltage output from the current adjustment unit 60. The bias voltage is supplied to gates of these PMOS transistors 58a, and each of the PMOS transistors 58a supplies the same correction current to each of the connection paths 55a via the switches 61.

The display device 1 according to the present embodiment has technical features in the internal configuration and operation of the H-DRV unit 13. Hereinafter, the internal configuration and operation of the H-DRV unit 13 of the present embodiment will be described in detail. The display device 1 according to the present embodiment employs a system in which an offset voltage Vofs is supplied to the ramp wiring 55, threshold correction and mobility correction of the drive transistor 42 in the pixel circuit 15 are performed, and then a second ramp wave voltage is supplied to generate a signal voltage.

The ramp buffer 51, which switches to the offset voltage or the second ramp wave voltage and outputs the switched voltage, is connected to one end side of the ramp wiring 55. A plurality of signal lines is connected to the ramp wiring 55 via the plurality of voltage holding units 56, and wiring resistance on the ramp wiring 55 increases as a distance from the ramp buffer 51 increases. Therefore, for example, in a case where the ramp buffer 51 supplies a ramp wave voltage to the ramp wiring 55, a voltage of the connection paths 55a between the ramp wiring 55 and the plurality of voltage holding units 56 may fluctuate depending on a position of the connection path 55a.

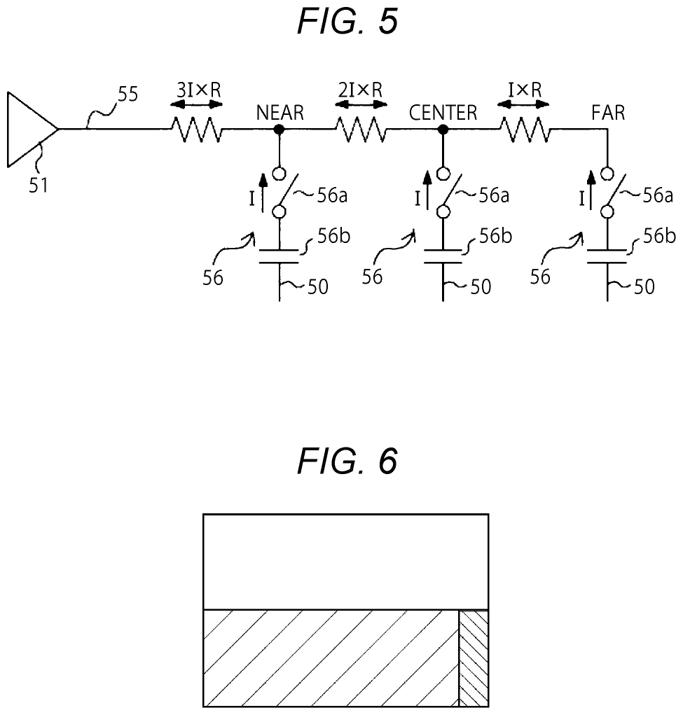

FIG. 5 is an equivalent circuit diagram in a case where three voltage holding units 56 are connected to the ramp wiring 55. Although not illustrated in FIG. 5, the pixel circuit 15 is connected to each of the voltage holding units 56 via a corresponding signal line. Although a large number of voltage holding units 56 are connected to the ramp wiring 55 in practice, only three voltage holding units 56 are illustrated in a simplified manner in FIG. 5. Each voltage holding unit 56 is equivalently represented by a switch 56a and a capacitance diagram 41. The capacitance diagram 41 illustrates a parasitic capacitance on the signal line 50.

In FIG. 5, it is assumed that wiring resistances R on the ramp wiring 55 are all equal on the connection path 55a between the ramp buffer 51 and the three voltage holding units 56. For example, in a case where white luminance is set for each of the pixel circuits 15, the switches 61 between the plurality of correction current sources 58 and the respective connection paths 55a are turned off so that the correction current from the correction current sources 58 does not flow through the connection paths 55a. Each of the voltage holding units 56 holds a voltage level when the ramp wave voltage is sufficiently small. At this time, current flows from each of the voltage holding units 56 to the ramp buffer 51 via the ramp wiring 55. In FIG. 5, it is assumed that currents I that flow through the connection paths 55a between the respective voltage holding units 56 and the ramp wiring 55 are all equal. Because a current I flows between the connection path 55a at the farthest end and the connection path 55a second farthest from the ramp buffer 51, a voltage drop in this section is I×R. Because a current of 2I flows between the connection path 55a at the nearest end and the connection path 55a second farthest from the ramp buffer 51, a voltage drop in this section is 2I×R. Because a current of 3I flows between the connection path 55a at the nearest end from an output node of the ramp buffer 51, a voltage drop in this section is 3I×R.

Thus, because a voltage drop occurs between the connection paths 55a with the plurality of voltage holding units 56 in a case where white luminance is set for each pixel, voltages of the connection paths 55a differ from one another, and a voltage level is higher as the connection path 55a is farther from the ramp buffer 51. A variation in voltage of the connection paths 55a with the plurality of voltage holding units 56 on the ramp wiring 55 causes a variation in luminance of the display screen.

For example, FIG. 6 illustrates an example in which an image with white luminance is displayed in an upper half of the display screen, an image with white luminance is displayed in a region on one end side in a horizontal direction of a lower half of the display screen, and an image with black luminance is displayed in the remaining region of the lower half of the display screen. It is assumed that one end side in the horizontal direction is a position at the farthest end from the ramp buffer 51.

In the example in FIG. 6, there is a difference in brightness between the white luminance of the upper half of the display screen and the white luminance on the one end side in the horizontal direction of the lower half. In practice, an example is illustrated in which the white luminance of the one end side in the horizontal direction of the lower half is darker than the white luminance of the upper half. In some cases, there may be a case where the white luminance of the one end side in the horizontal direction of the lower half is brighter than the white luminance of the upper half.

Such a luminance difference is caused by a wiring resistance on the ramp wiring 55 and whether or not a correction current is supplied from the correction current sources 58 to the respective connection paths 55a. In the present specification, for convenience, such a luminance difference is referred to as horizontal crosstalk.

In the present embodiment, a measure is taken to prevent horizontal crosstalk as illustrated in FIG. 6. In the present embodiment, horizontal crosstalk is reduced by supplying a correction current of an optimum amount of current from the plurality of correction current sources 58 to each of the connection paths 55a with the plurality of voltage holding units 56 on the ramp wiring 55.

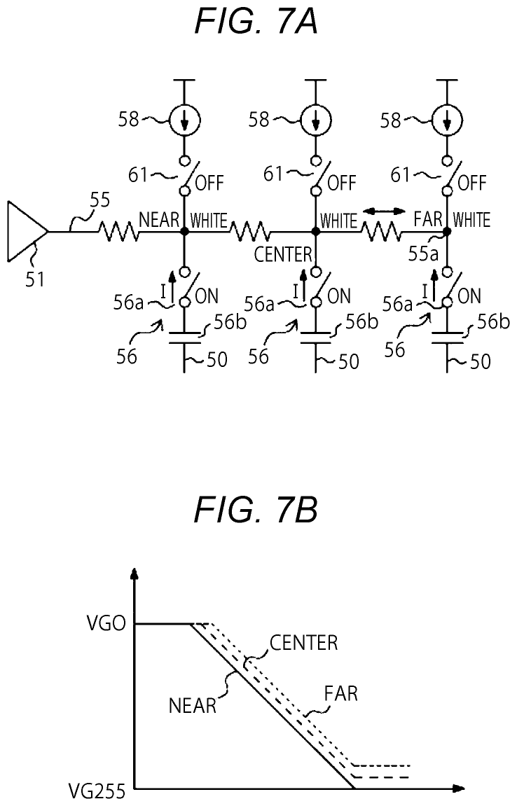

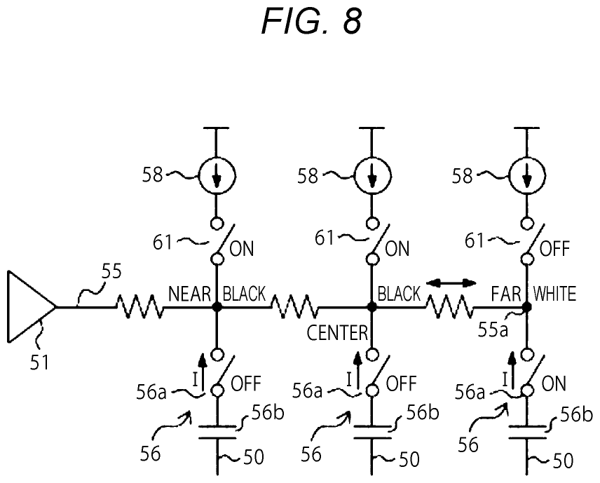

FIG. 7A and 8 are diagrams schematically illustrating operation by the current adjustment unit 60. As illustrated in FIGS. 7A and 8, the plurality of correction current sources 58 is connected via the plurality of switches 61 on the connection paths 55a to which the plurality of voltage holding units 56 on the ramp wiring 55 is connected. For simplification, FIGS. 7A and 8 illustrate examples in which three correction current sources 58 are connected to three connection paths 55a via three switches 61. The correction current output from the plurality of correction current sources 58 is adjusted by the current adjustment unit 60. The plurality of correction current sources 58 outputs the same correction current. A switch 61 is provided between each of the correction current sources 58 and a corresponding connection path 55a, and each of the switches 61 can be individually turned on or off. Therefore, whether or not to pass the correction current through each of the connection paths 55a can be set for each connection path 55a.

FIG. 7A illustrates an example in which white luminance is set in each of the pixel circuits 15. In this case, all the switches 61 of the correction current sources 58 are turned off, and the switches 56a of the three voltage holding units 56 are turned on. With this arrangement, similarly to FIG. 6, current flows from the voltage holding units 56 to the ramp buffer 51 via the connection paths 55a. Therefore, voltage of the connection path 55a at the farthest end from the ramp buffer 51 is highest. FIG. 7B is a diagram schematically illustrating voltage levels of the connection paths 55a with the respective voltage holding units 56 on the ramp wiring 55. In FIG. 7B, a horizontal axis represents time, and a vertical axis represents a voltage level. As illustrated, a connection path 55a farther from the ramp buffer 51 has a higher voltage level. Although FIG. 7B illustrates an example of ramp wave voltages of which voltage levels decrease from VG0 to VG255 with a constant gradient, ramp wave voltages of which the voltage levels increase from VG0 to VG255 with a constant gradient may be used. In that case also, a connection path 55a farther from the ramp buffer 51 has a higher voltage level of ramp wave voltage.

FIG. 8 illustrates an example in which white luminance is set for the pixel circuit 15 at the farthest end on the ramp wiring 55, and black luminance is set for the other pixel circuits 15. In this case, the switches 56a of the voltage holding units 56 connected to the pixel circuits 15 to which the black luminance is set are turned off, and the switches 61 of the correction current sources 58 are turned on. Therefore, the current I flows from each current source to the pixel circuit 15 for setting the black luminance, and the current I flows from the voltage holding unit 56 to the pixel circuit 15 for setting the white luminance via the ramp wiring 55. As can be seen from FIGS. 5, 7A, and 8, the voltages of the connection paths 55a are maintained at an equivalent level in any state. With this arrangement, as illustrated in FIG. 6, in a case where the upper half has white luminance, the one end side in the horizontal direction of the lower half has white luminance, and the remaining region has black luminance, there is no difference in brightness between the white luminance of the upper half and the white luminance of the one end side in the horizontal direction of the lower half.

As described above, the current adjustment unit 60 according to the present embodiment adjusts the correction current output from the correction current source 58 such that the current flowing through the ramp buffer 51 in the case of FIG. 8 matches the current flowing through the ramp buffer 51 in FIG. 7A. That is, when black luminance is set (at a time of a black raster), the voltage of the connection path 55a at the farthest end is intentionally raised.

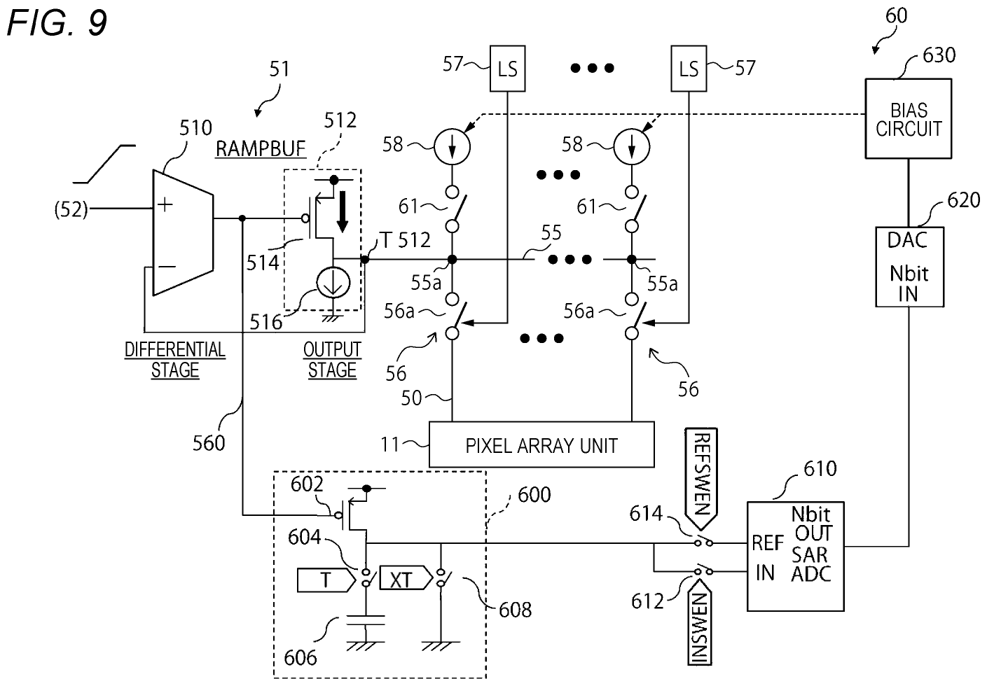

FIG. 9 is a block diagram illustrating a configuration example of the current adjustment unit 60 according to the present embodiment. The current adjustment unit 60 includes a current-voltage conversion unit 600, a voltage comparator 610, an adjustment signal generation unit 620, and a bias circuit 630.

The current-voltage conversion unit 600 includes a common-source transistor 602, a plurality of switches 604 and 608, and a capacitor 606. The switch 604 and the switch 608 are turned on and off according to the control signals T and XT.

A path 560 branched from the ramp buffer 51 in a current mirror manner is connected to the gate of the common-source transistor 602. Further, in the common-source transistor 602, a voltage source is connected to a drain, and a source is connected to one end of the switch 604 and the switch 608.

Thereby, the common-source transistor 602 supplies a proportional current proportional to the current flowing through the ramp wiring 55 to one end of either the switch 604 or the switch 608 according to the instruction signal of the differential stage 510. That is, when the switch 604 is turned on, the common-source transistor 602 acts as a current mirror, and supplies a proportional current proportional to the current flowing through the ramp wiring 55 to the capacitor 606. Note that the proportional constant of the proportional current can be adjusted by the characteristics of the common-source transistor 602.

As can be seen from these, when the switch 604 is turned on, a charge corresponding to the proportional current is accumulated in the capacitor 606, and when the switch 608 is turned on, the charge of the capacitor 606 is reset to 0. Note that the switch 604 is turned on when the signal T is high, and the switch 608 is turned on after the reset time when the signal XT is high. As described above, in the current-voltage conversion unit 600, the proportional current flowing while the switch 604 is turned on is converted into a voltage by the capacitor 606.

The voltage comparator 610 is, for example, a successive approximation type analog-to-digital converter (SAR ADC). The voltage comparator 610 is supplied with a potential from the current-voltage conversion unit 600 via the plurality of switches 612 and 614. In a case where the switch 612 is turned off and the switch 614 is turned on, the reference potential REF is supplied from the current-voltage conversion unit 600 to the terminal REF. On the other hand, in a case where the switch 612 is turned on and the switch 614 is turned off, the comparison potential IN is supplied from the current-voltage conversion unit 600 to the terminal IN. Then, the voltage comparator 610 outputs a signal corresponding to a voltage difference between the reference potential and the comparison potential. Note that the switch 612 is turned on when the signal INSWEN is high, and the switch 614 is turned on when the signal REFSWEN is high. That is, the signal INSWEN and the signal REFSWEN are exclusive. Note that the voltage comparator 610 may use a pipeline analog-to-digital converter instead of the SARADC. The use of the pipeline analog-to-digital converter enables higher accuracy.

On the basis of the signal output from the voltage comparator 610, the adjustment signal generation unit 620 generates an adjustment signal of a plurality of bits for the current adjustment unit 60 to adjust the correction current. In addition, the adjustment signal generation unit 620 holds the generated adjustment signal.

The bias circuit 630 generates a bias voltage on the basis of the adjustment signal generated by the adjustment signal generation unit 620. Then, the plurality of correction current sources 58 controls the correction current according to the bias voltage output from the bias circuit 630.

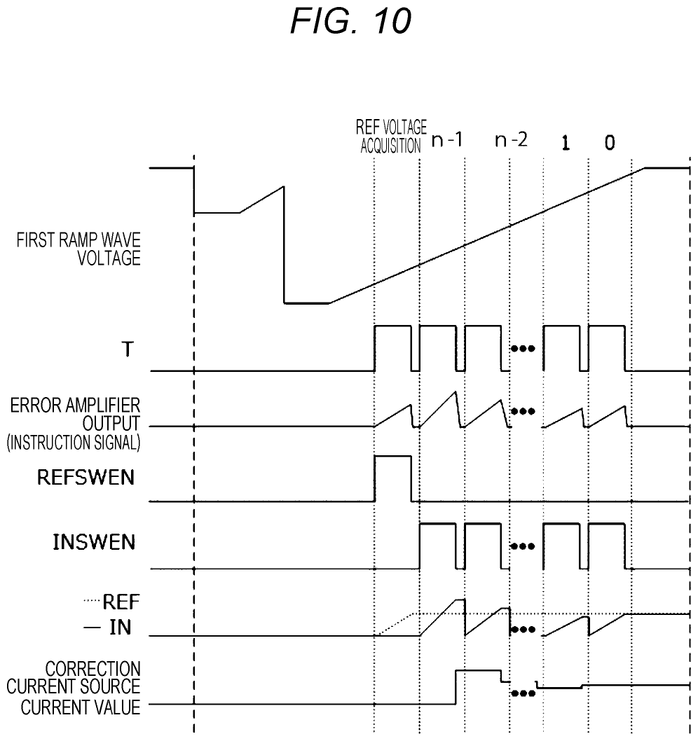

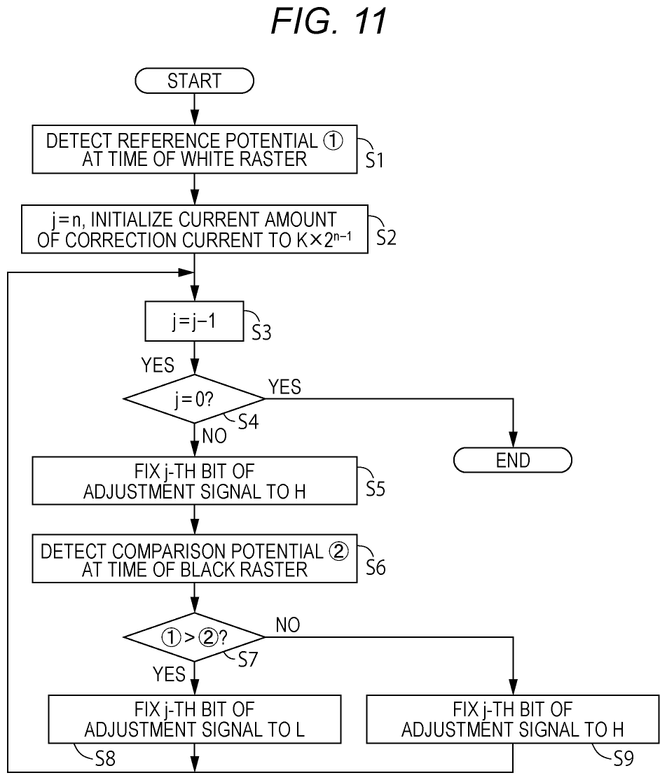

FIG. 10 is a time chart illustrating a processing operation of the current adjustment unit 60 of FIG. 9. The vertical axis indicates the first ramp wave voltage, the ON time signal T of the switch 604, the value of the instruction signal, the signal REFSWEN, the signal INSWEN, the reference potential REF, the comparison potential IN, and the current value of the correction current source 58 in order from the top. The horizontal axis represents time. FIG. 11 is a flowchart illustrating a processing operation of the current adjustment unit 60 in FIG. 9.

As illustrated in FIG. 11, as the REF acquisition period (see FIG. 10), the switches 604 and 614 are turned on in a state (at the time of white raster) in which white luminance is set to all the pixel circuits 15 connected to a certain horizontal line. As a result, the instruction signal in the state where the white luminance is set is output. At this time, a proportional current proportional to the current flowing through the ramp wiring 55 in the state where the white luminance is set is accumulated in the capacitor 606. The reference potential REF indicated by a dotted line fluctuates according to the charge accumulated in the capacitor 606, and the potential at the moment when the switch 604 and the switch 614 are turned off is held as the REF voltage in the voltage comparator 610 (step S1).

Next, current amounts of the plurality of correction current sources 58 are initialized to K×2ⁿ⁻¹, and a variable j indicating the number of adjustment times is initialized to n (step S2). Next, j is decremented by 1 (step S3).

Next, it is determined whether or not j=0 (step S4). If j=0, the processing ends. If j=0 is not satisfied, a j-th bit of the adjustment signal is fixed to H (step S5). Next, the switches 604 and 614 are turned on at the time of driving the total current source that drives the total correction current source 58 (at the time of black raster). As a result, in a period n−1, an instruction signal in which the correction current amount is K×2ⁿ⁻¹ is output, and a proportional current in which the correction current amount is K×2ⁿ⁻¹ is accumulated in the capacitor 606. The comparison potential IN indicated by the solid line fluctuates according to the charge accumulated in the capacitor 606, and the potential at the moment when the switch 604 and the switch 614 are turned off is input to the voltage comparator 610 as the IN voltage. The voltage comparator 610 determines whether or not the voltage is higher than the voltage detected in step S6 (step S7). The determination processing in step S7 is performed by the voltage comparator 610, and the output of the voltage comparator 610 indicates the determination result in step S7. Note that the time variation of the instruction signal in the period T in which the switch 604 is turned on and the time variation of the potential based on the capacitor 606 have similar shapes. In other words, the difference between the REF voltage, which is a potential based on the capacitor 606, and the comparison potential IN is equivalent to the difference between the instruction signals.

In a case where step S7 is YES, the j-th bit of the adjustment signal is changed to L (step S8). With this arrangement, the correction current output from the correction current source 58 is adjusted. Thereafter, the processing in and after step S3 is repeated.

Meanwhile, in a case where step S7 is NO, the j-th bit of the adjustment signal is fixed to H (step S9), and the processing in and after step S3 is repeated.

Thus, in the successive-approximation method, a plurality of bits of an adjustment signal is confirmed bit by bit each time of adjustment. That is, the correction current amount is adjusted such that the time variation of the instruction signal in step S1 coincides with the time variation of the instruction signal during the black raster. In other words, when the correction current amount in step S1 and the correction current amount in the black raster match, the time variation of the instruction signal in step S1 and the time variation of the instruction signal during the black raster match. Note that, when the time variation of the instruction signal in step S1 coincides with the time variation of the instruction signal during the black raster, the reference potential REF coincides with the comparison potential IN.

As described above, the path 560 is branched from the ramp buffer 51, and the current proportional to the current flowing through the terminal T512 is output from the common-source transistor 602 on the basis of the instruction signal serving as the information to be compared for correction. In addition, this current is applied to the capacitor 606 for a certain period of time to perform current-voltage conversion. As a result, voltage comparison can be performed at any voltage regardless of the potential difference generated between the near end and the far end of the ramp buffer of the ramp wiring 55. Therefore, the 1-bit correction accuracy of the successive approximation type analog-to-digital converter can be improved. In addition, since the specification required for the voltage comparator 610 is reduced, there is also an effect of suppressing the size of the voltage comparator 610. Furthermore, since the first ramp voltage wave is increased at a constant ratio with respect to time during the RAMP period, there is no restriction on the sample hold (S/H timing) of the proportional current, and it is possible to correct all bits within 1H which is during one RAMP period.

As described above, in the first embodiment, the current adjustment unit 60 adjusts the correction current on the basis of the difference between the instruction signals of the differential stage 510 in the case where the correction current flows through the plurality of connection paths 55a and the case where the correction current does not flow through the plurality of connection paths 55a. As a result, in a case where a region on an upper half of the display screen is set to white luminance, a region on the one end side in the horizontal direction of a lower half of the display screen is set to white luminance, and the remaining lower half region of the display screen is set to black luminance, a luminance difference between the white luminance of the region on the upper half and the white luminance of the region on the one end side in the horizontal direction of the lower half can be made inconspicuous.

### Modification 1 of First Embodiment

A display device 1 according to Modification 1 of the first embodiment is different from the display device 1 according to the first embodiment in that a power supply potential of a current-voltage conversion unit 600a is connected to one end side of a capacitor 606a. Hereinafter, differences from the display device 1 according to the first embodiment will be described.

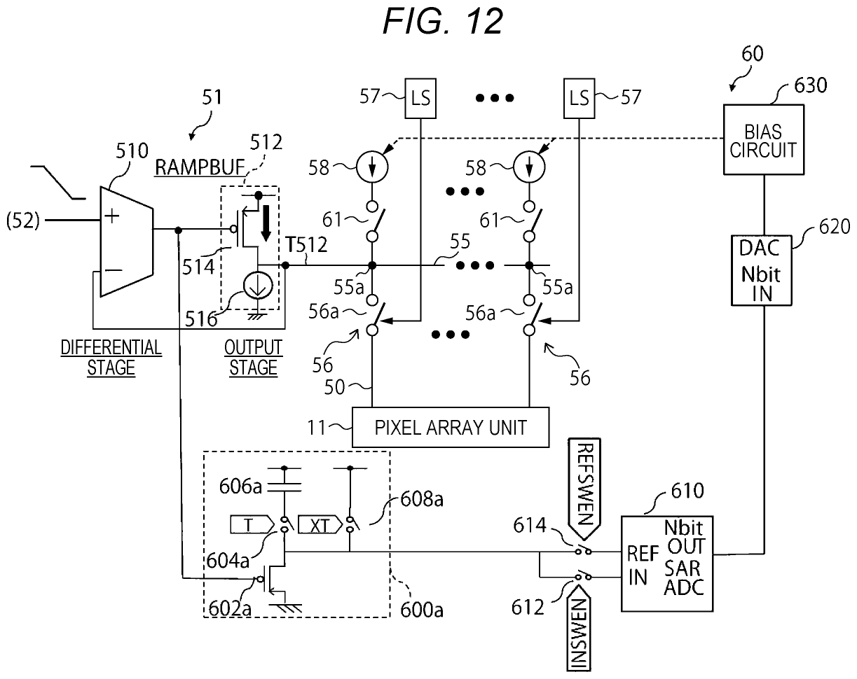

FIG. 12 is a block diagram illustrating a configuration example of a current adjustment unit 60 according to Modification 1 of the first embodiment. The current adjustment unit 60 includes a current-voltage conversion unit 600a, a voltage comparator 610, an adjustment signal generation unit 620, and a bias circuit 630.

The current-voltage conversion unit 600a includes a common-source transistor 602a, a plurality of switches 604a and 608a, and a capacitor 606a. A ground potential of the common-source transistor 602a is connected to a drain, and a source thereof is connected to one ends of the switch 604a and the switch 608a. Thereby, the common-source transistor 602a discharges a proportional current proportional to the current flowing through the ramp wiring 55 from one end of either the switch 604 or the switch 608 according to the instruction signal. That is, when the switch 604a is turned on, the charge corresponding to the proportional current is discharged from the capacitor 606, and when the switch 608 is turned on, the charge of the capacitor 606 is charged to the reference potential. The switch 604a is turned on when the signal T is high, and the switch 608a is turned on when the signal XT is high. Note that the switch 608a is turned off after the charge time has elapsed when the signal T is high.

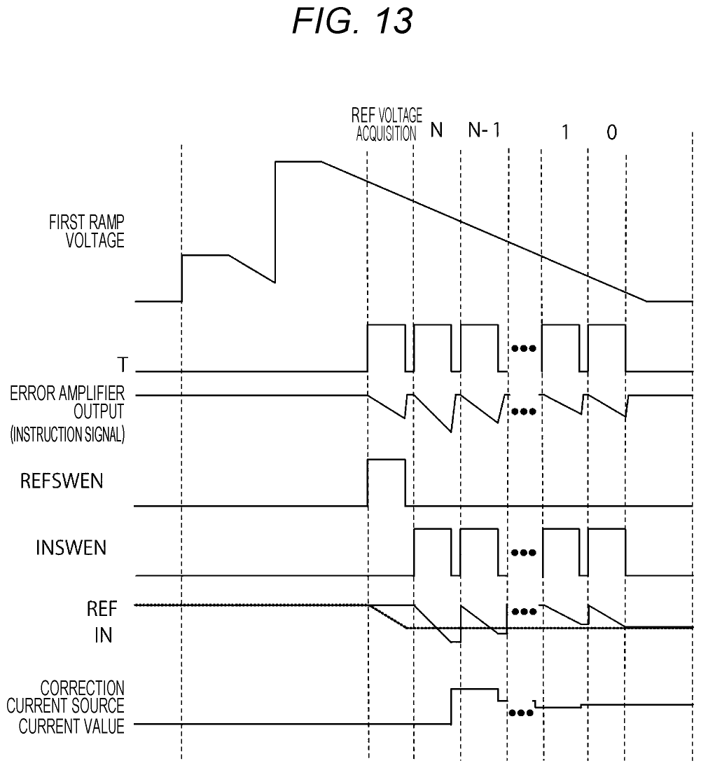

FIG. 13 is a time chart illustrating a processing operation of the current adjustment unit 60 of FIG. 12. The vertical axis indicates the first ramp wave voltage, the ON time of the switch 604, the value of the instruction signal, the signal REFSWEN, the signal INSWEN, the reference potential REF, the comparison potential IN, and the current value of the correction current source 58 in order from the top. The horizontal axis represents time. As described above, in the current-voltage conversion unit 600a, the current proportional to the current flowing through the ramp buffer 51 is converted into the voltage by the capacitor 606. Also in this case, the time variation of the instruction signal in the period T in which the switch 604 is turned on and the time variation of the potential based on the capacitor 606 have similar shapes. In other words, although the potential is based on the capacitor 606, the difference between the REF voltage and the comparison potential IN is equivalent to the difference between the instruction signals. As described above, in Modification 1 of the first embodiment, the current adjustment unit 60 can adjust the correction current on the basis of the difference between the instruction signals of the differential stage 510 in the case where the correction current flows through the plurality of connection paths 55a and the case where the correction current does not flow through the plurality of connection paths 55a. As a result, in a case where a region on an upper half of the display screen is set to white luminance, a region on the one end side in the horizontal direction of a lower half of the display screen is set to white luminance, and the remaining lower half region of the display screen is set to black luminance, a luminance difference between the white luminance of the region on the upper half and the white luminance of the region on the one end side in the horizontal direction of the lower half can be made inconspicuous.

### Modification 2 of First Embodiment

A display device 1 according to Modification 2 of the first embodiment is different from the display device 1 according to Modification 1 of the first embodiment in that a capacitor 606a of a current-voltage conversion unit 600b is a resistor 606b. Hereinafter, differences from the display device 1 according to Modification 1 of the first embodiment will be described.

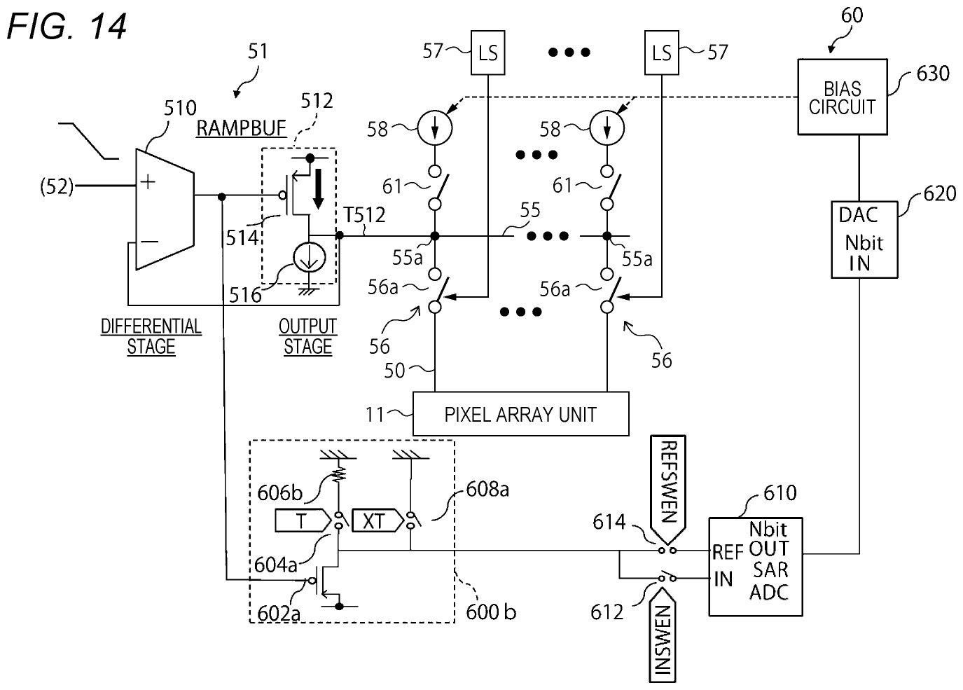

FIG. 14 is a block diagram illustrating a configuration example of a current adjustment unit 60 according to Modification 2 of the first embodiment. The current adjustment unit 60 includes a current-voltage conversion unit 600b, a voltage comparator 610, an adjustment signal generation unit 620, and a bias circuit 630.

The current-voltage conversion unit 600b includes a common-source transistor 602a, a plurality of switches 604a and 608a, and a resistor 606b. A ground potential of the common-source transistor 602a is connected to a drain, and a source thereof is connected to one ends of the switch 604a and the switch 608a. Thereby, the common-source transistor 602a supplies a proportional potential proportional to the current flowing through the ramp wiring 55 from one end of either the switch 604 or the switch 608 according to the instruction signal.

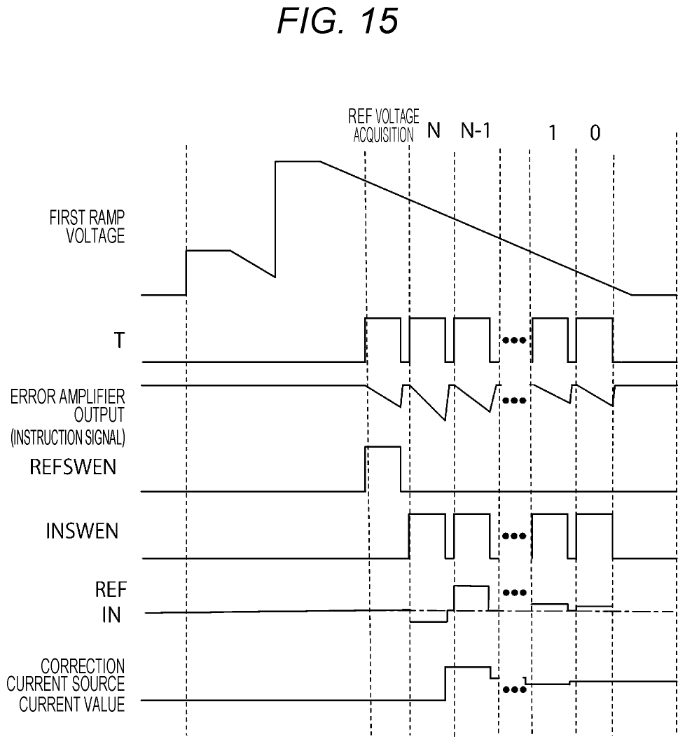

FIG. 15 is a time chart illustrating a processing operation of the current adjustment unit 60 of FIG. 14. The vertical axis indicates the first ramp wave voltage, the ON time of the switch 604, the value of the instruction signal, the signal REFSWEN, the signal INSWEN, the reference potential REF, the comparison potential IN, and the current value of the correction current source 58 in order from the top. The horizontal axis represents time. As described above, in the current-voltage conversion unit 600a, the current proportional to the current flowing through the ramp buffer 51 is converted into the voltage by the resistor 606b.

As described above, according to the present implementation form, since the capacitor 606a is the resistor 606b, the accumulation time in the capacitor 606a becomes unnecessary, the ON/OFF time of the switch 604 can be further shortened, and the adjustment time can be further shortened. As described above, also in Modification 2 of the first embodiment, the current adjustment unit 60 can adjust the correction current on the basis of the difference between the instruction signals of the differential stage 510 in the case where the correction current flows through the plurality of connection paths 55a and the case where the correction current does not flow through the plurality of connection paths 55a. As a result, in a case where a region on an upper half of the display screen is set to white luminance, a region on the one end side in the horizontal direction of a lower half of the display screen is set to white luminance, and the remaining lower half region of the display screen is set to black luminance, a luminance difference between the white luminance of the region on the upper half and the white luminance of the region on the one end side in the horizontal direction of the lower half can be made inconspicuous.

### Modification 3 of First Embodiment

A display device 1 according to Modification 3 of the first embodiment is different from the display device 1 according to the first embodiment in that the display device 1 does not include a current-voltage conversion unit 600b. Hereinafter, differences from the display device 1 according to Modification 1 of the first embodiment will be described.

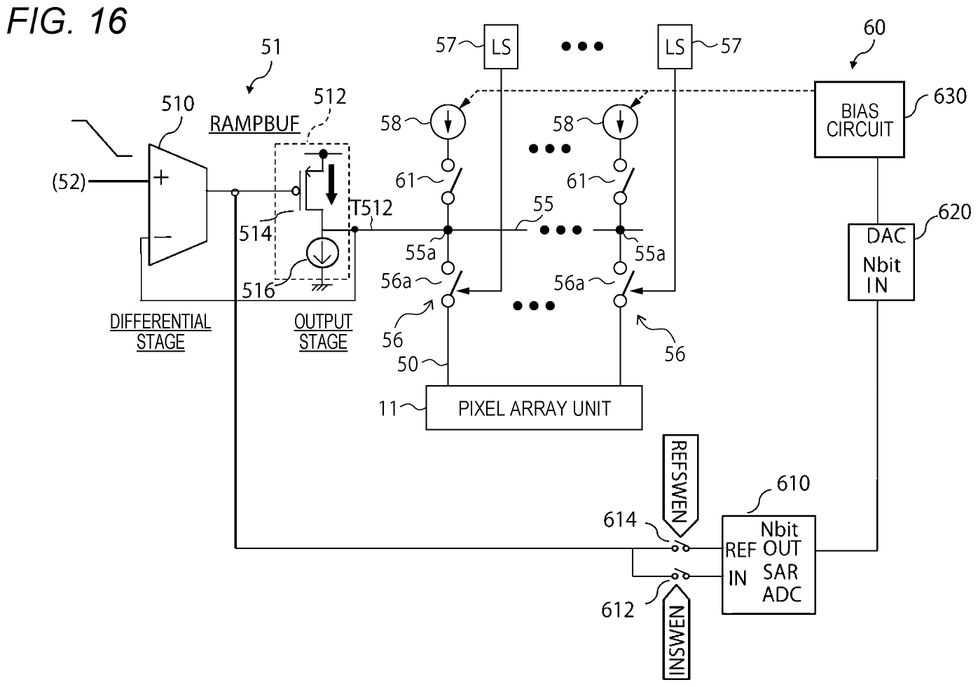

FIG. 16 is a block diagram illustrating a configuration example of a current adjustment unit 60 according to Modification 3 of the first embodiment. The current adjustment unit 60 includes a voltage comparator 610, an adjustment signal generation unit 620, and a bias circuit 630.

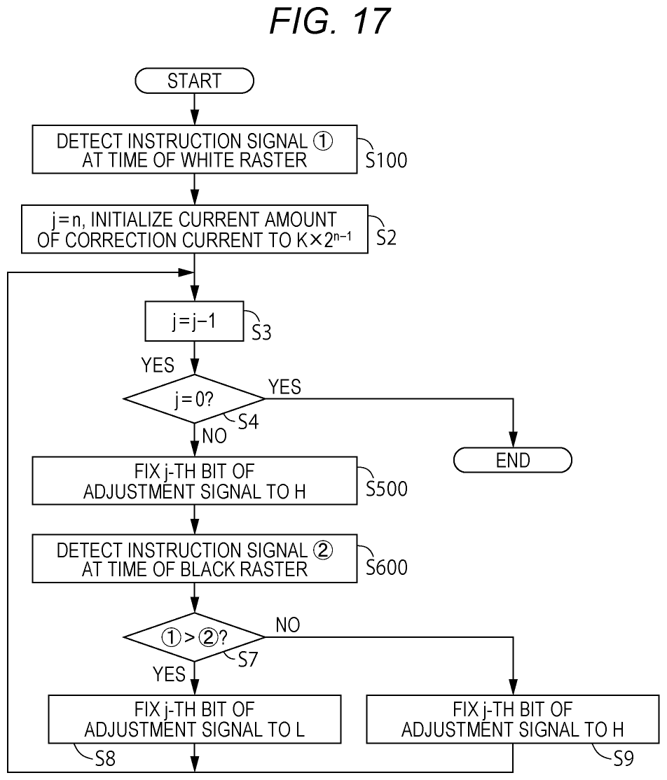

FIG. 17 is a flowchart illustrating a processing operation of the current adjustment unit 60 in FIG. 16.

First, in a state where the white luminance is set to all the pixel circuits 15 connected to a certain horizontal line (at the time of white raster), the switches 604 and 614 are turned on. As a result, the instruction signal in the state where the white luminance is set is output. The instruction signal at this time is held as the REF voltage in the voltage comparator 610 (step S100).

Next, current amounts of the plurality of correction current sources 58 are initialized to K×2ⁿ⁻¹, and a variable j indicating the number of adjustment times is initialized to n (step S2). Next, j is decremented by 1 (step S3).

Next, it is determined whether or not j=0 (step S4). If j=0, the processing ends. If j=0 is not satisfied, a j-th bit of the adjustment signal is fixed to H (step S5). Next, the switches 604 and 614 are turned on at the time of driving the total current source that drives the total correction current source 58 (at the time of black raster). As a result, an instruction signal in which the correction current amount is K×2ⁿ⁻¹ is output, and an instruction signal in which the correction current amount is K×2ⁿ⁻¹ is output. This instruction signal is input as an IN voltage to the voltage comparator 610 (step S600). The voltage comparator 610 determines whether or not the voltage is higher than the voltage detected in step S6 (step S7).

The determination processing in step S7 is performed by the voltage comparator 610, and the output of the voltage comparator 610 indicates the determination result in step S7.

In a case where step S7 is YES, the j-th bit of the adjustment signal is changed to L (step S8). With this arrangement, the correction current output from the correction current source 58 is adjusted. Thereafter, the processing in and after step S3 is repeated.

Meanwhile, in a case where step S7 is NO, the j-th bit of the adjustment signal is fixed to H (step S9), and the processing in and after step S3 is repeated.

As described above, in Modification 3 of the first embodiment, the current adjustment unit 60 can adjust the correction current on the basis of the difference between the instruction signals of the differential stage 510 in the case where the correction current flows through the plurality of connection paths 55a and the case where the correction current does not flow through the plurality of connection paths 55a. As a result, the display device 1 can be configured with a simpler configuration since the current-voltage conversion unit 600b is not provided. In this way, by adjusting the correction current on the basis of the difference between the instruction signals of the differential stage 510, in a case where a region on an upper half of the display screen is set to white luminance, a region on the one end side in the horizontal direction of a lower half of the display screen is set to white luminance, and the remaining lower half region of the display screen is set to black luminance, a luminance difference between the white luminance of the region on the upper half and the white luminance of the region on the one end side in the horizontal direction of the lower half can be made inconspicuous.

### Modification 4 of First Embodiment

A display device 1 according to Modification 4 of the first embodiment is different from the display device 1 according to Modification 3 of the first embodiment in that the display device 1 includes an integrator 640. Hereinafter, differences from the display device 1 according to Modification 3 of the first embodiment will be described.

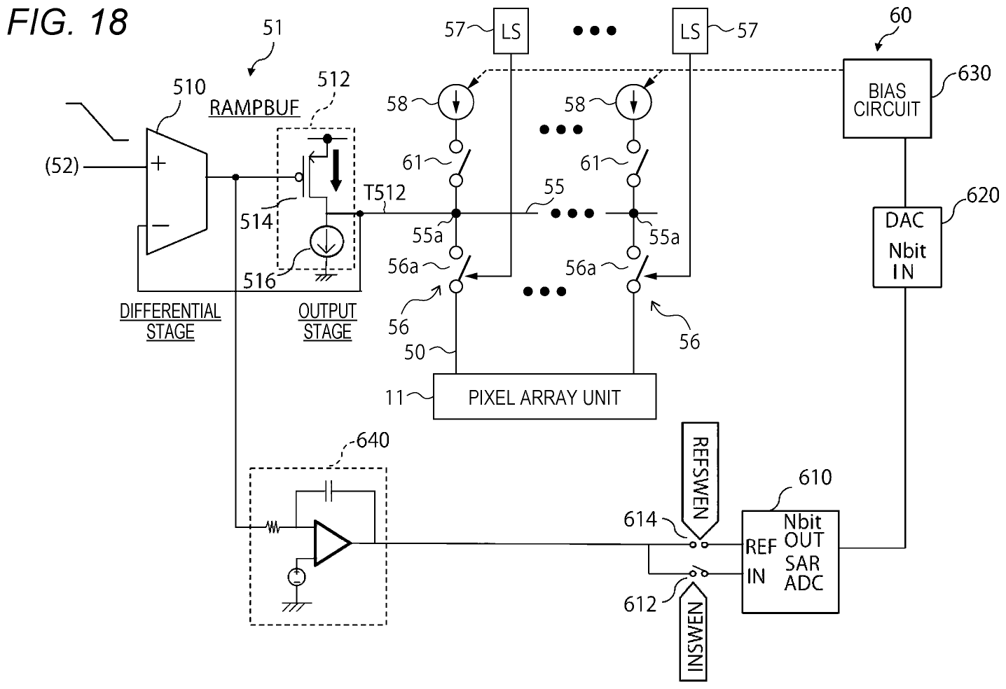

FIG. 18 is a block diagram illustrating a configuration example of a current adjustment unit 60 according to Modification 4 of the first embodiment. The current adjustment unit 60 includes a voltage comparator 610, an adjustment signal generation unit 620, a bias circuit 630, and an integrator 640. The voltage obtained by integrating the instruction signal in a predetermined period is supplied to the voltage comparator 610 by the integrator 640. Note that the integrator 640 according to the present embodiment corresponds to a current-voltage conversion unit. The feedback resistor of the integrator 640 may be replaced with a feedback capacitor.

As described above, in Modification 4 of the first embodiment, since the integral value of the instruction signal by the integrator 640 is supplied to the voltage comparator 610, it is possible to reflect the fluctuation of the instruction signal within the time T in the adjustment of the correction current. In this manner, by adjusting the correction current on the basis of the difference between the integral values of the instruction signals of the differential stage 510, in a case where the upper half region of the display screen is set to the white luminance, the lower half region on one end side in the horizontal direction is set to the white luminance, and the remaining lower half region is set to the black luminance in a state where the influence of the noise of the instruction signal is reduced, it is possible to make the luminance difference between the white luminance of the upper half and the white luminance of the lower half region on one end side in the horizontal direction inconspicuous.

### Modification 5 of First Embodiment

A display device 1 according to Modification 5 of the first embodiment is different from the display device 1 according to Modification 3 of the first embodiment in that the display device 1 includes an amplification unit 645. Hereinafter, differences from the display device 1 according to Modification 3 of the first embodiment will be described.

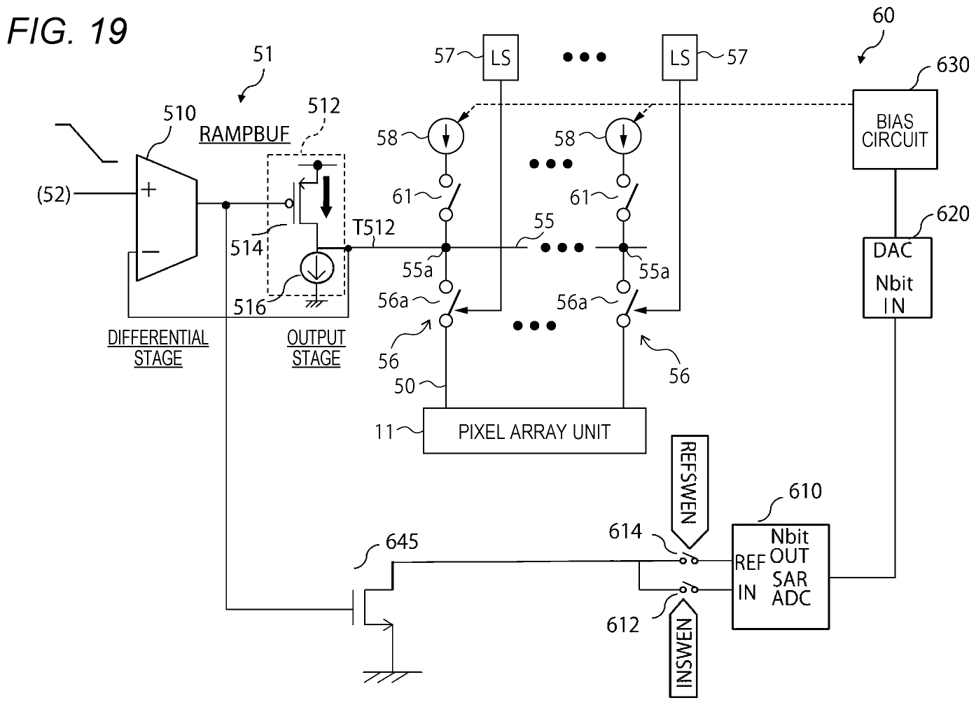

FIG. 19 is a block diagram illustrating a configuration example of a current adjustment unit 60 according to Modification 5 of the first embodiment. The current adjustment unit 60 includes a voltage comparator 610, an adjustment signal generation unit 620, a bias circuit 630, and an amplification unit 645. The amplification unit 645 is a transistor, and a path 560 branched from the ramp buffer 51 in a current mirror manner is connected to the gate. In addition, the transistor 645 has a drain connected to the voltage comparator 610 and a source grounded. The amplification unit 645 supplies the voltage obtained by amplifying the instruction signal to the voltage comparator 610. Note that the amplification unit 645 according to the present embodiment corresponds to a current-voltage conversion unit.

As described above, in Modification 5 of the first embodiment, since the instruction signal amplified by the transistor 645 is supplied to the voltage comparator 610, the voltage comparator 610 can be downsized. In this way, by adjusting the correction current on the basis of the difference in the amplification value of the instruction signal of the differential stage 510, in a case where the upper half region of the display screen is set to the white luminance, the lower half region on one end side in the horizontal direction is set to the white luminance, and the remaining lower half region is set to the black luminance in a state where the instruction signal is amplified, the luminance difference between the white luminance of the upper half region and the white luminance of the lower half region on one end side in the horizontal direction can be made inconspicuous.

### Modification 6 of First Embodiment

A display device 1 according to Modification 6 of the first embodiment is different from the display device 1 according to Modification 2 of the first embodiment in that the display device 1 includes a voltage comparator 660 configured by an analog circuit and a bias circuit 630a. Hereinafter, differences from the display device 1 according to Modification 3 of the first embodiment will be described.

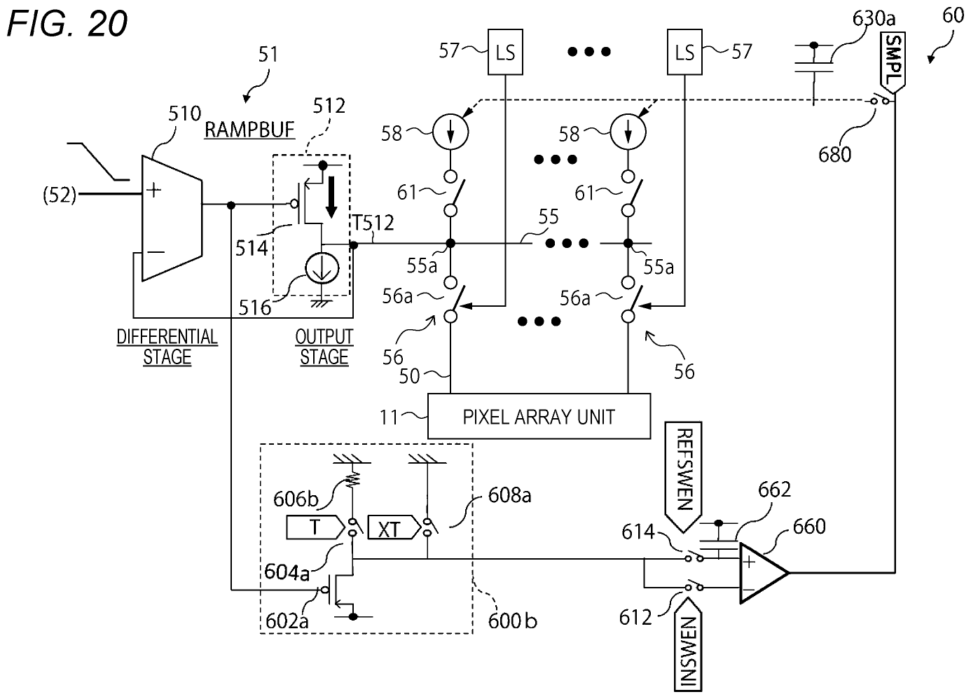

FIG. 20 is a block diagram illustrating a configuration example of a current adjustment unit 60 according to Modification 6 of the first embodiment. The current adjustment unit 60 includes a current-voltage conversion unit 600b, a voltage comparator 660, and a bias circuit 630a. The bias circuit 630a is a capacitor and further includes a switch 680. The voltage comparator 660 includes a reference capacitor 662.

The voltage comparator 660 is, for example, an error amplifier, and outputs a potential difference between the reference potential REF due to the charges accumulated in the reference capacitor 662 and the comparison potential IN in a case where the switch 612 is turned on.

The bias circuit 630a supplies a bias voltage to the gate (see FIG. 4B) of the NMOS transistor 58a. As a result, the correction current source 58 supplies the same correction current to each connection path 55a via the switch 61.

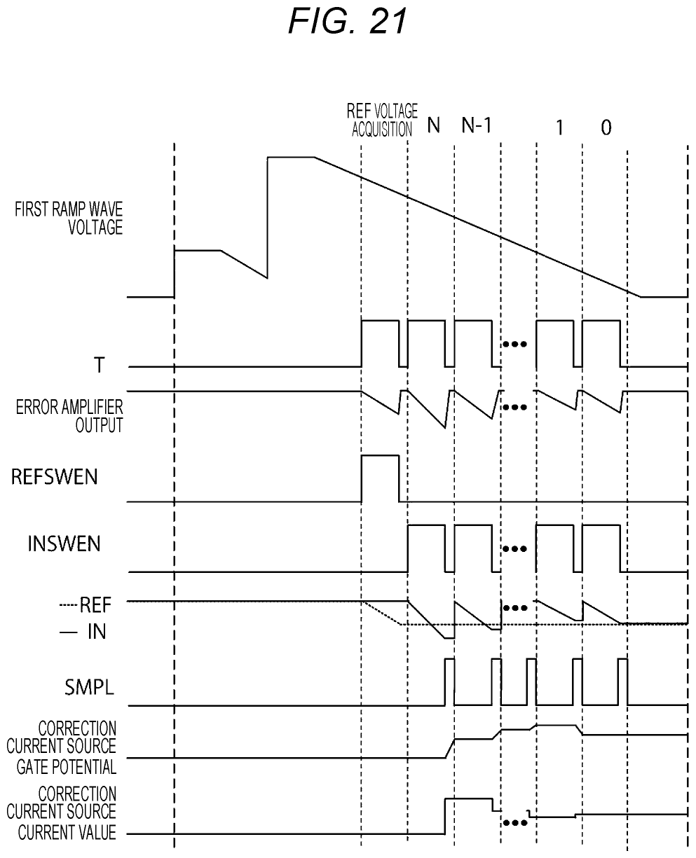

FIG. 21 is a time chart illustrating a processing operation of the current adjustment unit 60 of FIG. 20. The vertical axis indicates the first ramp wave voltage, the ON time of the switch 604, the value of the instruction signal, the signal REFSWEN, the signal

INSWEN, the reference potential REF, the comparison potential IN, the ON signal SMPL of the switch 680, the correction current source gate potential which is the potential of the bias circuit 630a, and the current value of the correction current source 58 in order from the top. The horizontal axis represents time.

First, in a state where the white luminance is set to all the pixel circuits 15 connected to a certain horizontal line (at the time of white raster), the switches 604a and 614 are turned on. As a result, the instruction signal in the state where the white luminance is set is output. At this time, a proportional potential proportional to the current flowing through the ramp wiring 55 in the state where the white luminance is set is accumulated in the capacitor 662. The reference potential REF indicated by a dotted line fluctuates and is held according to the charge accumulated in the capacitor 606.

Next, the switch 604a and the switch 614 are turned on at the time of driving the total current source that drives the total correction current source 58 (at the time of black raster). As a result, the instruction signal in the state where the black luminance is set is output. At this time, the proportional potential IN proportional to the current flowing through the ramp wiring 55 in the state where the black luminance is set is input to the voltage comparator 660. The potential of the bias circuit 630a fluctuates depending on the potential difference output from the voltage comparator 660 when the switch 680 is turned on, and is applied to the gate of the NMOS transistor 58a. As can be seen from these, the potential of the bias circuit 630a is controlled so that the reference potential REF is equal to the comparison potential IN.

As described above, according to Modification 6 of the first embodiment, the current adjustment unit 60 can adjust the correction current on the basis of the difference between the instruction signals of the differential stage 510 in the case where the correction current flows through the plurality of connection paths 55a and the case where the correction current does not flow through the plurality of connection paths 55a. In this case, the current adjustment unit 60 can be configured only by the analog circuit, and the current adjustment unit 60 can be further downsized. In this way, by adjusting the correction current on the basis of the difference between the instruction signals of the differential stage 510, in a case where the value of the correction current is fed back by the analog circuit, the upper half region of the display screen is set to the white luminance, the lower half region on one end side in the horizontal direction is set to the white luminance, and the remaining lower half region is set to the black luminance, it is possible to make the luminance difference between the white luminance of the upper half region and the white luminance of the lower half region on one end side in the horizontal direction inconspicuous.

### Modification 7 of First Embodiment

A display device 1 according to Modification 7 of the first embodiment is different from the display device 1 according to Modification 2 of the first embodiment in that a voltage comparator 662 includes a comparator. Hereinafter, differences from the display device 1 according to Modification 2 of the first embodiment will be described.

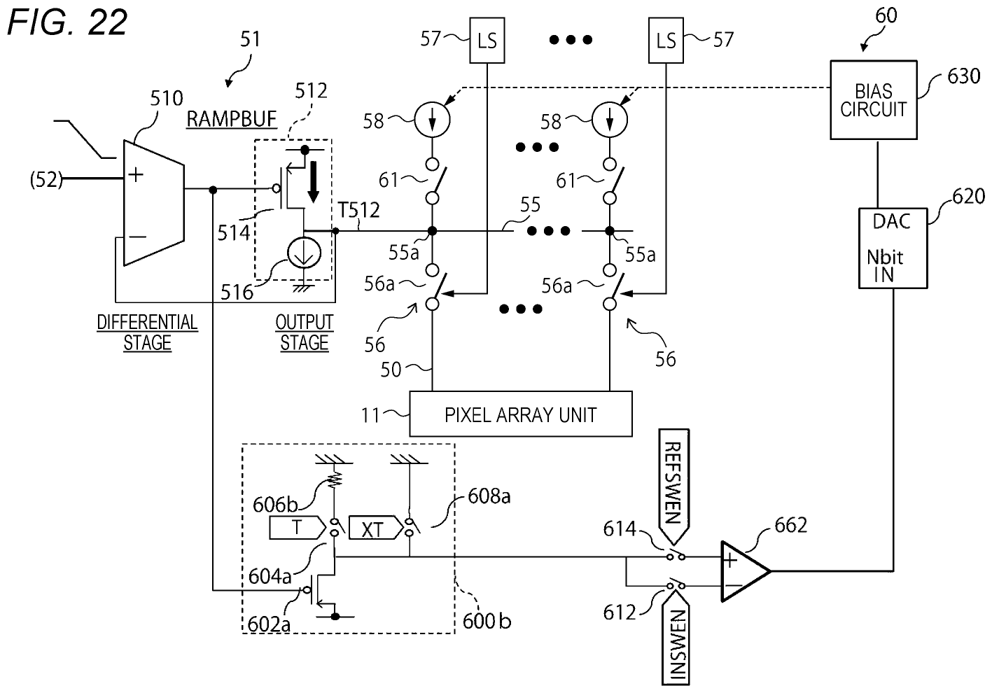

FIG. 22 is a block diagram illustrating a configuration example of a current adjustment unit 60 according to Modification 7 of the first embodiment. The voltage comparator 662 includes a comparator. The output voltage of the differential stage 510 during white display is sampled and held at the negative input of the comparator 662. Then, the adjustment signal generation unit 620 sequentially changes the N-bit (Nbit) correction value. As a result, a correction current corresponding to the adjustment signal sequentially changed by the adjustment signal generation unit 620 is supplied to the ramp wiring 55. At this time, a potential proportional to the instruction signal output from the differential stage 510 is applied to the positive input of the comparator. Then, when the output value of the comparator 662 is inverted, the N-bit correction value is determined. As a search method for determining the N-bit correction value, linear search, binary search, or the like can be used.

As described above, according to Modification 7 of the first embodiment, the current adjustment unit 60 can adjust the correction current on the basis of the difference between the instruction signals of the differential stage 510 in the case where the correction current flows through the plurality of connection paths 55a and the case where the correction current does not flow through the plurality of connection paths 55a. In this case, the comparator 662 constitutes the comparison unit, and the current adjustment unit 60 can be further downsized. In this way, by adjusting the correction current on the basis of the difference between the instruction signals of the differential stage 510, in a case where the value of the correction current is fed back by the analog circuit, the upper half region of the display screen is set to the white luminance, the lower half region on one end side in the horizontal direction is set to the white luminance, and the remaining lower half region is set to the black luminance, it is possible to make the luminance difference between the white luminance of the upper half region and the white luminance of the lower half region on one end side in the horizontal direction inconspicuous.

### Modification 8 of First Embodiment

A display device 1 according to Modification 8 of the first embodiment is different from the display device 1 according to Modification 2 of the first embodiment in that the voltage comparator 662 includes a comparator and further includes a phase comparator 680 and a charge pump 690. Hereinafter, differences from the display device 1 according to Modification 2 of the first embodiment will be described.

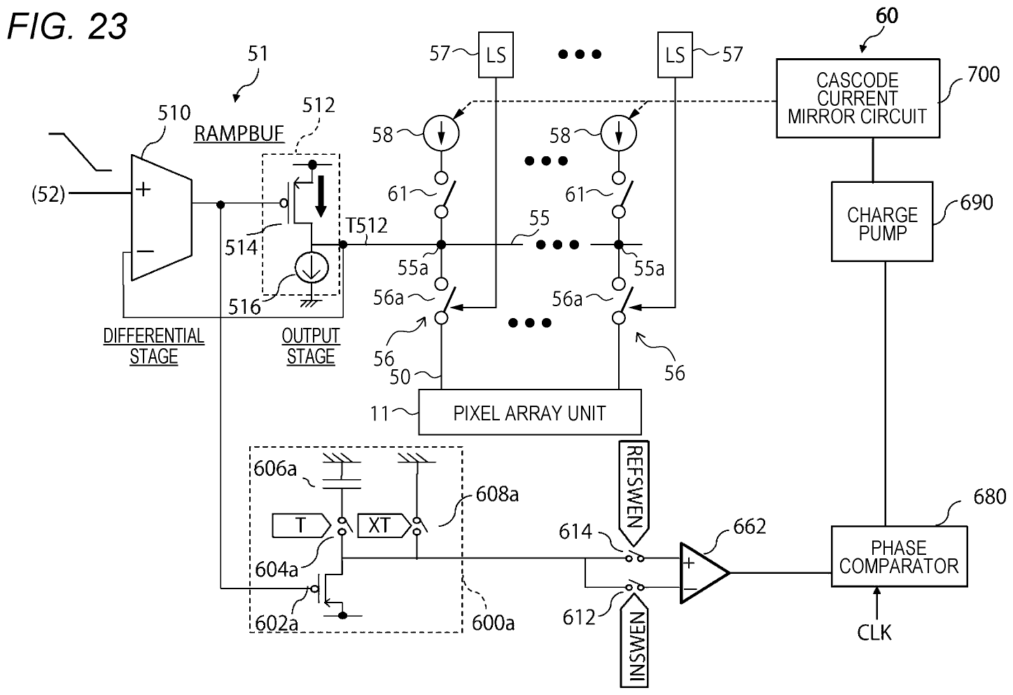

FIG. 23 is a block diagram illustrating a configuration example of a current adjustment unit 60 according to Modification 8 of the first embodiment. A phase comparator 680 connected to an output path of the comparator 662, a charge pump 690, and a cascode current mirror circuit 700 are included. Similarly to FIG. 20, the correction current source 58 includes a plurality of NMOS transistors operating at the same gate voltage.

The phase comparator 680 outputs a phase difference pulse between the output signal of the comparator 662 and a reference pulse signal that is pulse-output at a timing determined for each horizontal line. The charge pump 690 performs control such that the current source of the charge pump 690 causes a constant current to flow during the period of the phase difference pulse output from the phase comparator 680.

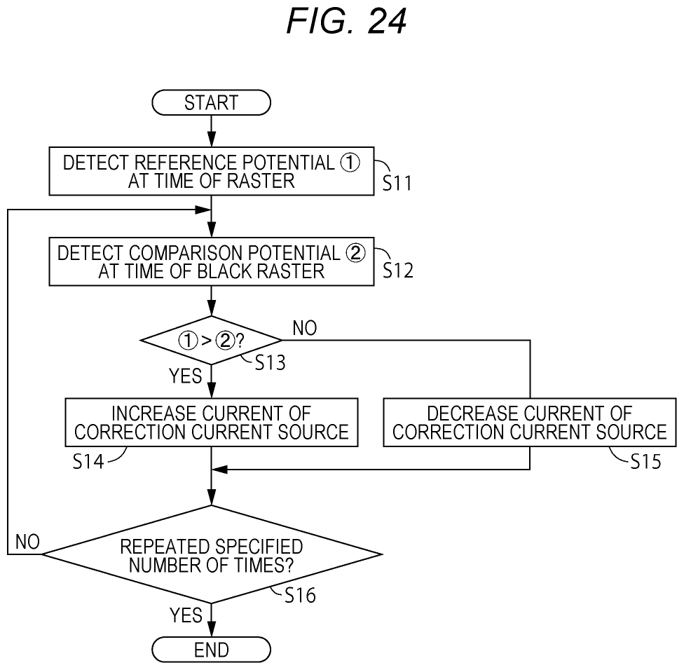

FIG. 24 is a flowchart illustrating a processing operation of the current adjustment unit 60 in FIG. 23. First, in a state where the white luminance is set to all the pixel circuits 15 connected to a certain horizontal line (at the time of white raster), the switches 604 and 614 are turned on. As a result, the instruction signal in the state where the white luminance is set is output. At this time, a proportional current proportional to the current flowing through the ramp wiring 55 in the state where the white luminance is set is accumulated in the capacitor 606a. The reference potential REF fluctuates according to the charge accumulated in the capacitor 606a, and the potential at the moment when the switch 604a and the switch 614a are turned off is held as the REF voltage in the voltage comparator 662 (step S11).

Next, the switches 604a and 614a are turned on at the time of driving the total current source that drives the total correction current source 58 (at the time of black raster). At this time, a proportional current proportional to the current flowing through the ramp wiring 55 in the state where the black luminance is set is accumulated in the capacitor 606a. The comparison potential IN fluctuates according to the charges accumulated in the capacitor 606, and the potential at the moment when the switch 604a and the switch 614a are turned off is held as the comparison potential IN in the voltage comparator 662 (step S12).

Next, it is determined whether or not the voltage detected in step S11 is higher than the voltage detected in step S12 (step S13). The determination processing in step S13 is performed by the voltage comparator 662, and the output of the voltage comparator 662 indicates the determination result in step S13.

In a case where step S13 is YES, control to increase the correction current is performed (step S14), and the processing in and after step S12 is repeated. Meanwhile, in a case where step S13 is NO, control to reduce the correction current is performed (step S15).

Next, it is determined whether or not the correction current has been adjusted a specified number of times (step S16). If the specified number of times has not been reached, the processing in and after step S12 is repeated. If the specified number of times has been reached, the processing ends.

As described above, in Modification 8 of the first embodiment, the correction current can be adjusted on the basis of the difference between the instruction signals of the differential stage 510 in the case where the correction current flows through the plurality of connection paths 55a and the case where the correction current does not flow through the plurality of connection paths 55a.

### Modification 9 of First Embodiment

The display device 1 according to Modification 9 of the first embodiment is different from the display device 1 according to the first embodiment in that the correction current is adjusted such that the total current amount of the correction current source matches the output stage current at the time of writing voltages of the Vofs DAC 53 in all pixels. Hereinafter, differences from the display device 1 according to the first embodiment will be described.

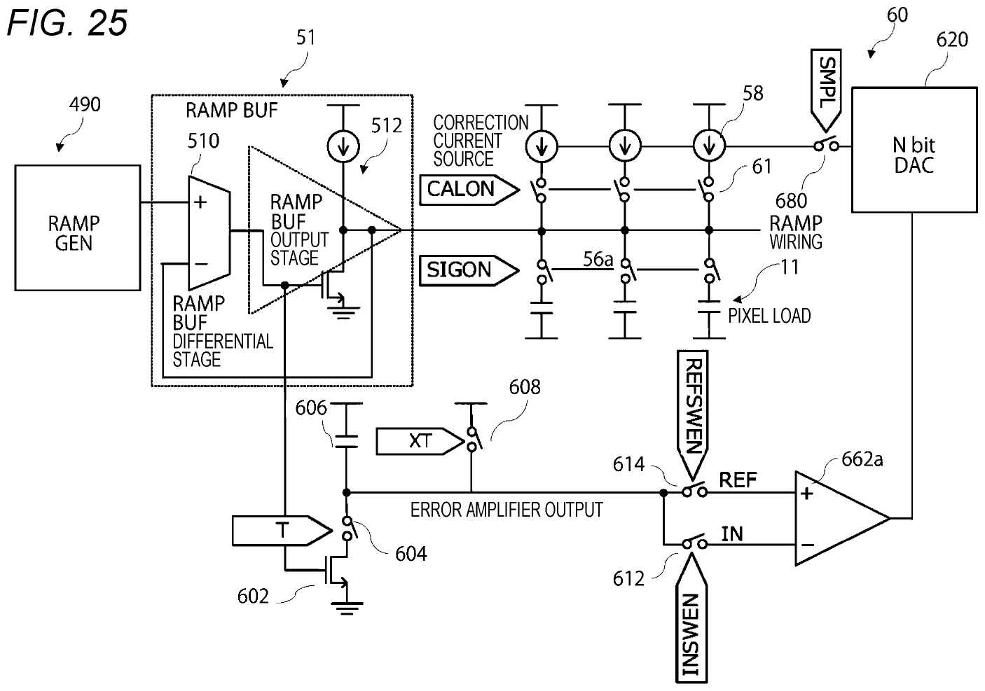

FIG. 25 is a block diagram illustrating a configuration example of a current adjustment unit 60 according to Modification 9 of the first embodiment. Similarly to FIG. 20, the correction current source 58 includes a plurality of NMOS transistors operating at the same gate voltage. The ramp power supply 490 includes a selector 49 (see FIG. 4A), a ramp wave generation circuit 52 (see FIG. 4A), and a Vofs DAC 53 (see FIG. 4A). The voltage comparator 662a is, for example, an error amplifier, and outputs a potential difference between the reference potential REF due to the charges accumulated in the reference capacitor 662 and the comparison potential IN in a case where the switch 612 is turned on.

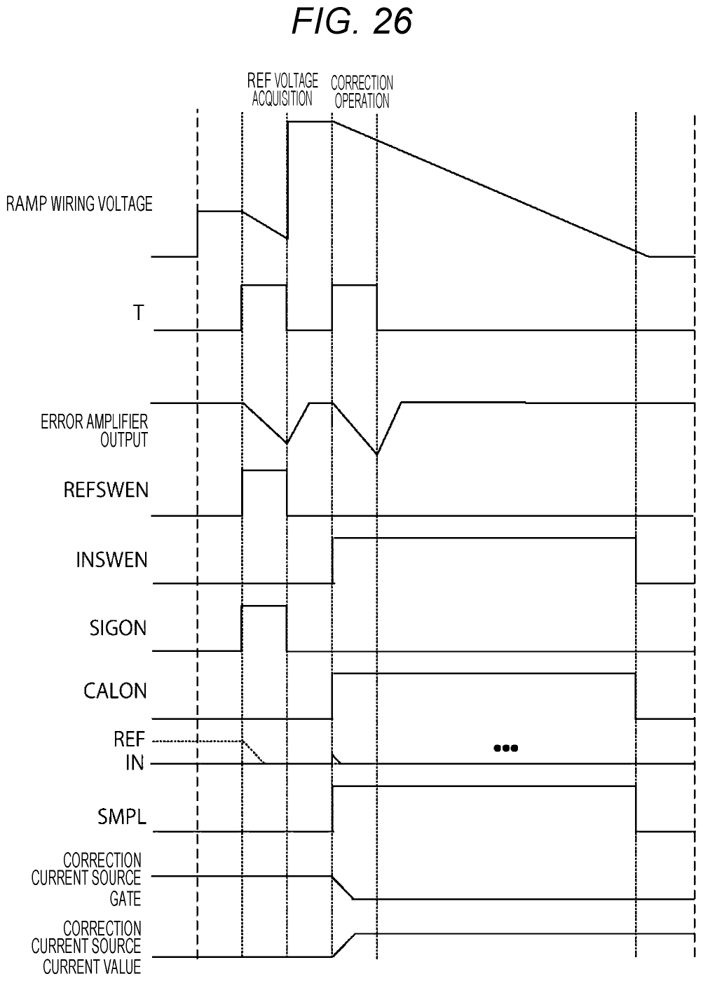

FIG. 26 is a time chart illustrating a processing operation of the current adjustment unit 60 of FIG. 25. The vertical axis indicates, in order from the top, the ramp wiring voltage, the ON time signal T of the switch 604, the output of the differential stage 510 (error amplifier), the signal REFSWEN, the signal INSWEN, the signal SIGON which is the ON signal of the switch 61, the signal CALON which is the ON signal of the switch 56a, the reference potential REF, the comparison potential IN, the signal SMPL which is the ON signal of the switch 680, the gate voltage of the correction current source 58, and the current value of the correction current source 58. The horizontal axis represents time. In the present embodiment, similarly to FIG. 7B, a case of a ramp wave voltage in which the voltage level decreases from VG0 to VG255 with a constant gradient will be described. Note that, similarly to the first embodiment, a ramp wave voltage whose voltage level rises from VG0 to VG255 with a constant gradient may be used.

The first state according to the present embodiment is, for example, a state in which all the switches 56a are turned on and all the switches 61 are turned off. This first state is when the offset voltage VOFS for all the pixels of the Vofs DAC 53 (see FIG. 4A) is set, and corresponds to the writing state of the reference voltage. The second state according to the present embodiment is, for example, a state in which all the switches 56a are turned off and all the switches 61 are turned on. The second luminance is, for example, black luminance and corresponds to the black gradation writing state.

As illustrated in FIG. 26, in the REF acquisition period, in a state in which the offset voltage VOFS of the Vofs DAC 53 is set to all the pixel circuits 15, the ON time signal T, the signal REFSWEN, and the signal SIGON are set to the high level in synchronization with each other, and the switch 604 and the switch 614 are turned on. As a result, the instruction signal of the differential stage 510 at the time of VOFS writing is output. At this time, a proportional current proportional to the current flowing through the ramp wiring 55 in the state at the time of VOFS writing is accumulated in the capacitor 606. The reference potential REF indicated by a dotted line fluctuates according to the charge accumulated in the capacitor 606, and the potential at the moment when the switch 604 and the switch 614 are turned off is held as the REF voltage in the error amplifier 662a.

Next, a ramp wave is output from the ramp wave generation circuit 52 (see FIG. 4A) at the time of driving the total current source (at the time of black raster) that drives the total correction current source 58, the ON time signal T becomes a high level, and the switch 604 and the switch 614 are turned on. At the moment when the ON time signal T goes to a high level, the signal INSWEN and the signal SMPL go to a high level in synchronization with each other. The signal INSWEN, the signal CAKON, and the signal SMPL maintain a high level until the ramp wave voltage of the ramp wave generation circuit 52 reaches a predetermined value.

At this time, a proportional current proportional to the current flowing through the ramp wiring 55 in the output state of the ramp wave of the ramp wave generation circuit 52 is accumulated in the capacitor 606. The potential IN indicated by a dotted line instantaneously fluctuates according to the charge accumulated in the capacitor 606, and the potential at the moment when the switch 604 and the switch 614 are turned off is held as the IN voltage in the error amplifier 662a.

The error amplifier 662a outputs a signal based on the difference between the REF voltage and the IN voltage to the adjustment signal generation unit 620. As a result, the correction current output from the correction current source 58 is adjusted so that the correction current at the time of driving the total current source (at the time of black raster) and the correction current at the time of VOFS writing become the same. As described above, in Modification 9 of the first embodiment, the correction current can be adjusted on the basis of the difference between the instruction signals of the differential stage 510 in the case where the correction current flows through the plurality of connection paths 55a and the case where the correction current does not flow through the plurality of connection paths 55a.

### Modification 10 of First Embodiment

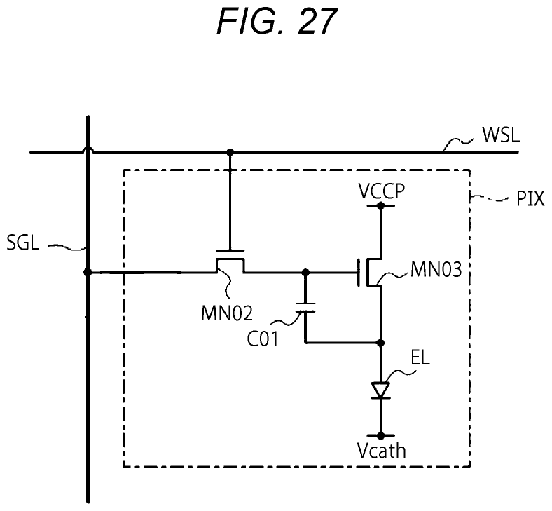

A configuration example of the pixel 11 will be described with reference to FIGS. 27 to 33 below. Hereinafter, the pixel 11 may be referred to as a pixel PIX. FIG. 27 illustrates a configuration example of the pixel PIX. The pixel PIX includes transistors MN02 to MN03, a capacitor C01, and a light emitting element EL. The transistors MN02 to MN03 are N-type metal oxide semiconductor field effect transistors (MOSFETs). The gate of the transistor MN02 is connected to the control line WSL, the drain is connected to the signal line SGL, and the source is connected to the gate of the transistor MN03 and the capacitor C01. One end of the capacitor C01 is connected to the source of the transistor MN02 and the gate of the transistor MN03, and the other end is connected to the source of the transistor MN03 and the anode of the light emitting element EL. The gate of the transistor MN03 is connected to the source of the transistor MN02 and one end of the capacitor C01, the drain is connected to the power supply line VCCP, and the source is connected to the other end of the capacitor C01 and the anode of the light emitting element EL. The light emitting element EL is, for example, an organic EL light emitting element, the anode is connected to the source of the transistor MN03 and the other end of the capacitor C01, and the cathode is connected to the power supply line Vcath.

With this configuration, in the pixel PIX, when the transistor MN02 is in the on state, the voltage between both ends of the capacitor C01 is set on the basis of the pixel signal supplied from the signal line SGL. The transistor MN03 causes a current corresponding to the voltage between both ends of the capacitor C01 to flow through the light emitting element EL. The light emitting element EL emits light on the basis of the current supplied from the transistor MN03. In this manner, the pixel PIX emits light with luminance corresponding to the pixel signal.

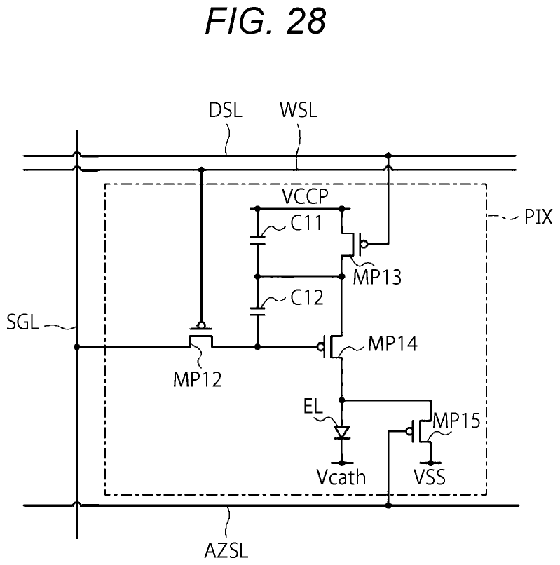

FIG. 28 illustrates another configuration example of the pixel PIX. The pixel PIX includes capacitors C11 and C12, transistors MP12 to MP15, and a light emitting element EL. The transistors MP12 to MP15 are P-type MOSFETs. The gate of the transistor MP12 is connected to the control line WSL, the source is connected to the signal line SGL, and the drain is connected to the gate of the transistor MP14 and the capacitor C12. One end of the capacitor C11 is connected to the power supply line VCCP, and the other end is connected to the capacitor C12, the drain of the transistor MP13, and the source of the transistor MP14. One end of the capacitor C12 is connected to the other end of the capacitor C11, the drain of the transistor MP13, and the source of the transistor MP14, and the other end is connected to the drain of the transistor MP12 and the gate of the transistor MP14. The gate of the transistor MP13 is connected to the control line DSL, the source is connected to the power supply line VCCP, and the drain is connected to the source of the transistor MP14, the other end of the capacitor C11, and one end of the capacitor C12. The gate of the transistor MP14 is connected to the drain of the transistor MP12 and the other end of the capacitor C12, the source is connected to the drain of the transistor MP13, the other end of the capacitor C11, and one end of the capacitor C12, and the drain is connected to the anode of the light emitting element EL and the source of the transistor MP15. The gate of the transistor MP15 is connected to the control line AZSL, the source is connected to the drain of the transistor MP14 and the anode of the light emitting element EL, and the drain is connected to the power supply line VSS.

With this configuration, in the pixel PIX, the transistor MP12 is in the on state, so that the voltage between both ends of the capacitor C12 is set on the basis of the pixel signal supplied from the signal line SGL. The transistor MP13 is turned on and off on the basis of the signal of the control line DSL. The transistor MP14 causes a current corresponding to the voltage between both ends of the capacitor C12 to flow through the light emitting element EL during the period in which the transistor MP13 is in the on state. The light emitting element EL emits light on the basis of the current supplied from the transistor MP14. In this manner, the pixel PIX emits light with luminance corresponding to the pixel signal. The transistor MP15 is turned on and off on the basis of the signal of the control line AZSL. During the period in which the transistor MP15 is in the on state, the voltage of the anode of the light emitting element EL is initialized by being set to the voltage of the power supply line VSS.

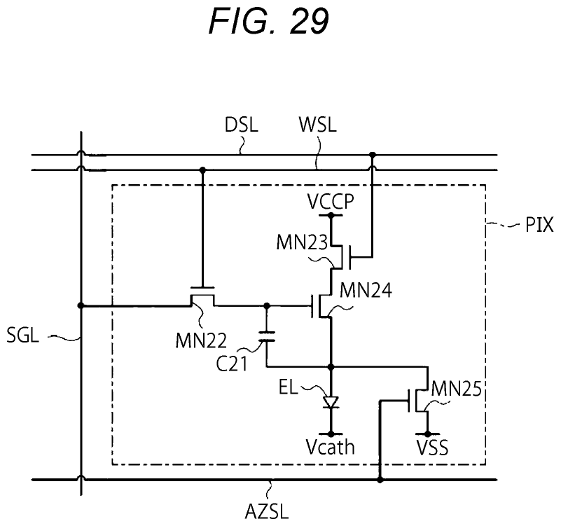

FIG. 29 illustrates another configuration example of the pixel PIX. The pixel PIX includes a capacitor C21, transistors MN22 to MN25, and a light emitting element EL. The transistors MN22 to MN25 are N-type MOSFETs. The gate of the transistor MN22 is connected to the control line WSL, the drain is connected to the signal line SGL, and the source is connected to the gate of the transistor MN24 and the capacitor C21. One end of the capacitor C21 is connected to the source of the transistor MN22 and the gate of the transistor MN24, and the other end is connected to the source of the transistor MN24, the drain of the transistor MN25, and the anode of the light emitting element EL. The gate of the transistor MN23 is connected to the control line DSL, the drain is connected to the power supply line VCCP, and the source is connected to the drain of the transistor MN24. The gate of the transistor MN24 is connected to the source of the transistor MN22 and one end of the capacitor C21, the drain is connected to the source of the transistor MN23, and the source is connected to the other end of the capacitor C21, the drain of the transistor MN25, and the anode of the light emitting element EL. The gate of the transistor MN25 is connected to the control line AZSL, the drain is connected to the source of the transistor MN24, the other end of the capacitor C21, and the anode of the light emitting element EL, and the source is connected to the power supply line VSS.

With this configuration, in the pixel PIX, when the transistor MN22 is in the on state, the voltage between both ends of the capacitor C21 is set on the basis of the pixel signal supplied from the signal line SGL. The transistor MN23 is turned on and off on the basis of the signal of the control line DSL. The transistor MN24 causes a current corresponding to the voltage between both ends of the capacitor C21 to flow to the light emitting element EL during the period in which the transistor MN23 is in the on state. The light emitting element EL emits light on the basis of the current supplied from the transistor MN24. In this manner, the pixel PIX emits light with luminance corresponding to the pixel signal. The transistor MN25 is turned on and off on the basis of the signal of the control line AZSL. During the period in which the transistor MN25 is in the on state, the voltage of the anode of the light emitting element EL is initialized by being set to the voltage of the power supply line VSS.

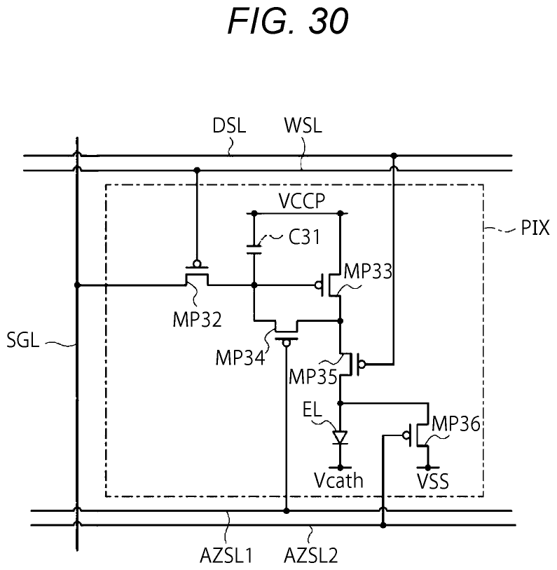

FIG. 30 illustrates another configuration example of the pixel PIX. The pixel PIX includes a capacitor C31, transistors MP32 to MP36, and a light emitting element EL. The transistors MP32 to MP36 are P-type MOSFETs. The gate of the transistor MP32 is connected to the control line WSL, the source is connected to the signal line SGL, and the drain is connected to the gate of the transistor MP33, the drain of the transistor MP34, and the capacitor C31. One end of the capacitor C31 is connected to the power supply line VCCP, and the other end is connected to the drain of the transistor MP32, the gate of the transistor MP33, and the drain of the transistor MP34. The gate of the transistor MP34 is connected to the control line AZSLI, the source is connected to the drain of the transistor MP33 and the source of the transistor MP35, and the drain is connected to the drain of the transistor MP32, the gate of the transistor MP33, and the other end of the capacitor C31. The gate of the transistor MP35 is connected to the control line DSL, the source is connected to the drain of the transistor MP33 and the source of the transistor MP34, and the drain is connected to the source of the transistor MP36 and the anode of the light emitting element EL. The gate of the transistor MP36 is connected to the control line AZSL2, the source is connected to the drain of the transistor MP35 and the anode of the light emitting element EL, and the drain is connected to the power supply line VSS.

With this configuration, in the pixel PIX, the transistor MP32 is in the on state, so that the voltage between both ends of the capacitor C31 is set on the basis of the pixel signal supplied from the signal line SGL. The transistor MP35 is turned on and off on the basis of the signal of the control line DSL. The transistor MP33 causes a current corresponding to the voltage between both ends of the capacitor C31 to flow to the light emitting element EL during the period in which the transistor MP35 is in the on state. The light emitting element EL emits light on the basis of the current supplied from the transistor MP33. In this manner, the pixel PIX emits light with luminance corresponding to the pixel signal. The transistor MP34 is turned on and off on the basis of the signal of the control line AZSL1. The drain and the gate of the transistor MP34 are connected to each other during the period in which the transistor MP33 is in the on state. The transistor MP36 is turned on and off on the basis of the signal of the control line AZSL2. During the period in which the transistor MP36 is in the on state, the voltage of the anode of the light emitting element EL is initialized by being set to the voltage of the power supply line VSS.

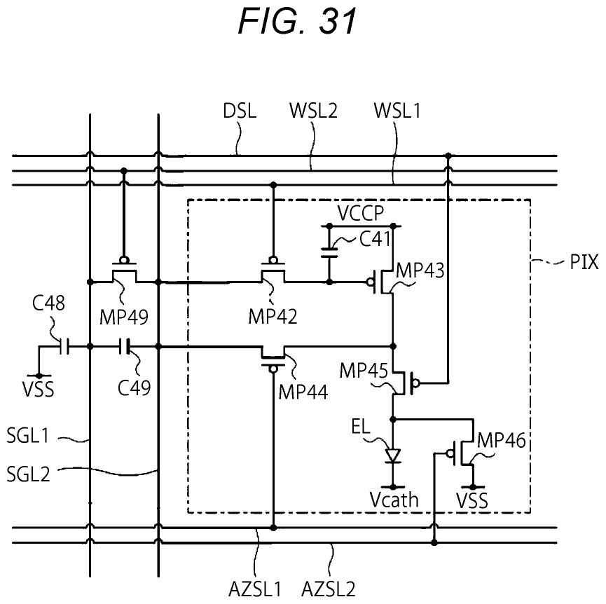

FIG. 31 illustrates another configuration example of the pixel PIX. One end of the capacitor C48 is connected to the signal line SGL1, and the other end is connected to the power supply line VSS. One end of the capacitor C49 is connected to the signal line SGL1, and the other end is connected to the signal line SGL2. The transistor MP49 is a P-type MOSFET, and has a gate connected to the control line WSL2, a source connected to the signal line SGL1, and a drain connected to the signal line SGL2.

The pixel PIX includes a capacitor C41, transistors MP42 to MP46, and a light emitting element EL. The transistors MP42 to MP46 are P-type MOSFETs. The gate of the transistor MP42 is connected to the control line WSL1, the source is connected to the signal line SGL2, and the drain is connected to the gate of the transistor MP43 and the capacitor C41. One end of the capacitor 41 is connected to the power supply line VCCP, and the other end is connected to the drain of the transistor MP42 and the gate of the transistor MP43. The gate of the transistor MP43 is connected to the drain of the transistor MP42 and the other end of the capacitor C41, the source is connected to the power supply line VCCP, and the drain is connected to the sources of the transistors MP44 and MP45. The gate of the transistor MP44 is connected to the control line AZSLI, the source is connected to the drain of the transistor MP43 and the source of the transistor MP45, and the drain is connected to the signal line SGL2. The gate of the transistor MP45 is connected to the control line DSL, the source is connected to the drain of the transistor MP43 and the source of the transistor MP44, and the drain is connected to the source of the transistor MP46 and the anode of the light emitting element EL. The gate of the transistor MP46 is connected to the control line AZSL2, the source is connected to the drain of the transistor MP45 and the anode of the light emitting element EL, and the drain is connected to the power supply line VSS.

With this configuration, in the pixel PIX, when the transistor MP42 is in the on state, the voltage between both ends of the capacitor C49 is set on the basis of the pixel signal supplied from the signal line SGLI via the capacitor C41. The transistor MP45 is turned on and off on the basis of the signal of the control line DSL. The transistor MP43 causes a current corresponding to the voltage between both ends of the capacitor C41 to flow through the light emitting element EL during the period in which the transistor MP45 is in the on state. The light emitting element EL emits light on the basis of the current supplied from the transistor MP43. In this manner, the pixel PIX emits light with luminance corresponding to the pixel signal. The transistor MP44 is turned on and off on the basis of the signal of the control line AZSL1. During the period in which the transistor MP44 is in the on state, the drain of the transistor MP43 and the signal line SGL2 are connected to each other. The transistor MP46 is turned on and off on the basis of the signal of the control line AZSL2. During the period in which the transistor MP46 is in the on state, the voltage of the anode of the light emitting element EL is initialized by being set to the voltage of the power supply line VSS.

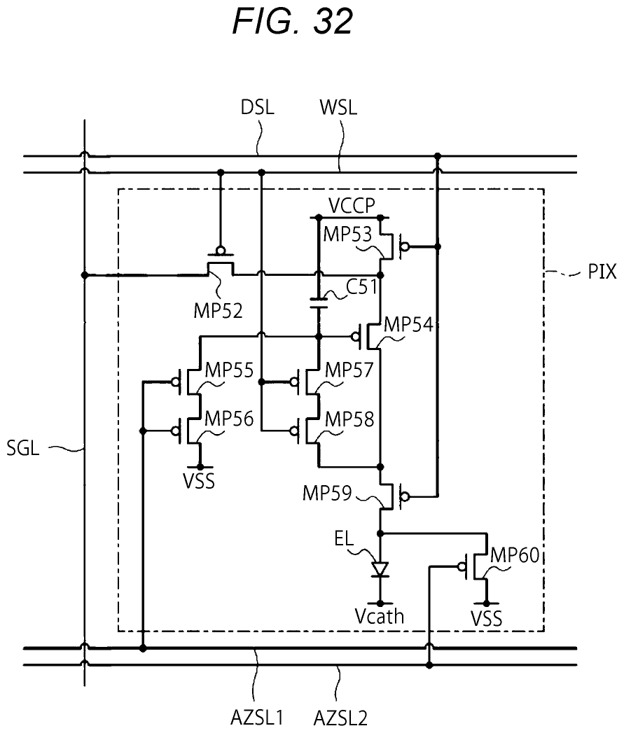

FIG. 32 illustrates another configuration example of the pixel PIX. The pixel PIX includes a capacitor C51, transistors MP52 to MP60, and a light emitting element EL. The transistors MP52 to MP60 are P-type MOSFETs. The gate of the transistor MP52 is connected to the control line WSL, the source is connected to the signal line SGL, and the drain is connected to the drain of the transistor MP53 and the source of the transistor MP54. The gate of the transistor MP53 is connected to the control line DSL, the source is connected to the power supply line VCCP, and the drain is connected to the drain of the transistor MP52 and the source of the transistor MP54. The gate of the transistor MP54 is connected to the source of the transistor MP55, the drain of the transistor MP57, and the capacitor C51, the source is connected to the drains of the transistors MP52 and MP53, and the drain is connected to the sources of the transistors MP58 and MP59. One end of the capacitor C51 is connected to the power supply line VCCP, and the other end is connected to the gate of the transistor MP54, the source of the transistor MP55, and the drain of the transistor MP57. The capacitor C51 may include two capacitors connected in parallel to each other. The gate of the transistor MP55 is connected to the control line AZSL1, the source is connected to the gate of the transistor MP54, the drain of the transistor MP57, and the other end of the capacitor C51, and the drain is connected to the source of the transistor MP56. The gate of the transistor MP56 is connected to the control line AZSL1, the source is connected to the drain of the transistor MP55, and the drain is connected to the power supply line VSS. The gate of the transistor MP57 is connected to the control line WSL, the drain is connected to the gate of the transistor MP54, the source of the transistor MP55, and the other end of the capacitor C51, and the source is connected to the drain of the transistor MP58. The gate of the transistor MP58 is connected to the control line WSL, the drain is connected to the source of the transistor MP57, and the source is connected to the drain of the transistor MP54 and the source of the transistor MP59. The gate of the transistor 59 is connected to the control line DSL, the source is connected to the drain of the transistor MP54 and the source of the transistor MP58, and the drain is connected to the source of the transistor MP60 and the anode of the light emitting element EL. The gate of the transistor MP60 is connected to the control line AZSL2, the source is connected to the drain of the transistor MP59 and the anode of the light emitting element EL, and the drain is connected to the power supply line VSS.

With this configuration, in the pixel PIX, the transistors MP52, MP54, MP58, and MP57 are in the on state, whereby the voltage between both ends of the capacitor C51 is set on the basis of the pixel signal supplied from the signal line SGL. The transistors MP53 and MP59 are turned on and off on the basis of the signal of the control line DSL. The transistor MP54 causes a current corresponding to the voltage between both ends of the capacitor C51 to flow to the light emitting element EL during the period in which the transistors MP53 and MP59 are in the on state. The light emitting element EL emits light on the basis of the current supplied from the transistor MP54. In this manner, the pixel PIX emits light with luminance corresponding to the pixel signal. The transistors MP55 and MP56 are turned on and off on the basis of the signal of the control line AZSL1. During the period in which the transistors MP55 and MP56 are in the on state, the voltage of the gate of the transistor MP54 is initialized by being set to the voltage of the power supply line VSS. The transistor MP60 is turned on and off on the basis of the signal of the control line AZSL2. During the period in which the transistor MP60 is in the on state, the voltage of the anode of the light emitting element EL is initialized by being set to the voltage of the power supply line VSS.

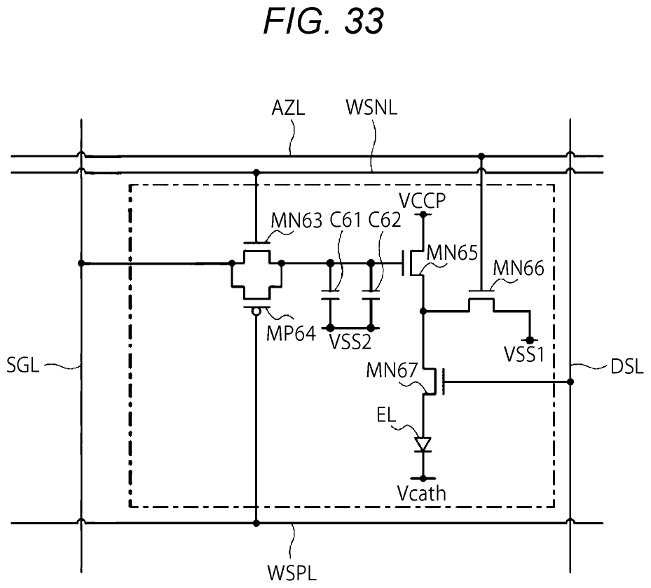

FIG. 33 illustrates another configuration example of the pixel PIX. The signal of the control line WSNL and the signal of the control line WSPL are inverted signals.

The pixel PIX includes capacitors C61 and C62, transistors MN63, MP64, and MN65 to MN67, and a light emitting element EL. The transistors MN63 and MN65 to MN67 are N-type MOSFETs, and the transistor MP64 is a P-type MOSFET. The gate of the transistor MN63 is connected to the control line WSNL, the drain is connected to the signal line SGL and the source of the transistor MP64, and the source is connected to the drain of the transistor MP64, the capacitors C61 and C62, and the gate of the transistor MN65. The gate of the transistor MP64 is connected to the control line WSPL, the source is connected to the signal line SGL and the drain of the transistor MN63, and the drain is connected to the source of the transistor MN63, the capacitors C61 and C62, and the gate of the transistor MN65. The capacitor C61 includes, for example, a metal oxide metal (MOM) capacitor, and has one end connected to the source of the transistor MN63, the drain of the transistor MP64, the capacitor C62, and the gate of the transistor MN65, and the other end connected to the power supply line VSS2. Note that the capacitor C61 may be configured using, for example, a MOS capacitor or a metal insulator metal (MIM) capacitor. The capacitor C62 includes, for example, a MOS capacitor, and has one end connected to the source of the transistor MN63, the drain of the transistor MP64, one end of the capacitor C61, and the gate of the transistor MN65, and the other end connected to the power supply line VSS2. Note that the capacitor C62 may be configured using, for example, an MOM capacitor or an MIM capacitor. The gate of the transistor MN65 is connected to the source of the transistor MN63, the drain of the transistor MP64, and one end of the capacitors C61 and C62, the drain is connected to the power supply line VCCP, and the source is connected to the drains of the transistors MN66 and MN67. The gate of the transistor MN66 is connected to the control line AZL, the drain is connected to the source of the transistor MN65 and the drain of the transistor MN67, and the source is connected to the power supply line VSS1. The gate of the transistor MN67 is connected to the control line DSL, the drain is connected to the source of the transistor MN65 and the drain of the transistor MN66, and the source is connected to the anode of the light emitting element EL.

With this configuration, in the pixel PIX, at least one of the transistors MN63 or MP64 is in the on state, so that the voltage between both ends of the capacitors C61 and C62 is set on the basis of the pixel signal supplied from the signal line SGL. The transistor MN67 is turned on and off on the basis of the signal of the control line DSL. The transistor MN65 causes a current corresponding to the voltage between both ends of the capacitors C61 and C62 to flow to the light emitting element EL during the period in which the transistor MN67 is in the on state. The light emitting element EL emits light on the basis of the current supplied from the transistor MP65. In this manner, the pixel PIX emits light with luminance corresponding to the pixel signal. The transistor MN66 may be turned on and off on the basis of the signal of the control line AZL. Furthermore, the transistor MN66 may function as a resistance element having a resistance value corresponding to the signal of the control line AZL. In this case, the transistor MN65 and the transistor MN66 constitute a so-called source follower circuit.

### APPLICATION EXAMPLE

Next, application examples of the display system described in the above embodiment and modifications will be described.

### Application Example 1

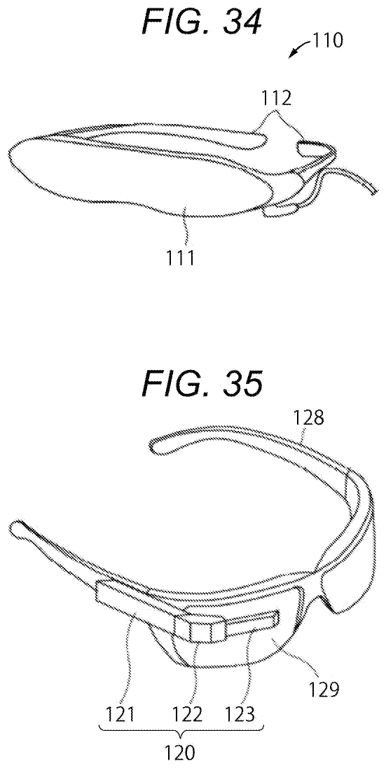

FIG. 34 illustrates an example of an external appearance of a head mounted display 110. The head mounted display 110 includes, for example, ear hooking portions 112 to be worn on the head of the user on both sides of the glass-shaped display unit 111. The technology according to the above embodiment and the like can be applied to such a head mounted display 110.

### Application Example 2

FIG. 35 illustrates an example of an external appearance of another head mounted display 120. The head mounted display 120 is a transmissive head mounted display including a main body portion 121, an arm portion 122, and a lens barrel portion 123. The head mounted display 120 is mounted on glasses 128. The main body portion 121 includes a control board and a display unit for controlling the operation of the head mounted display 120. The display unit emits image light of a display image. The arm portion 122 connects the main body portion 121 and the lens barrel portion 123 and supports the lens barrel portion 123. The lens barrel portion 123 projects image light supplied from the main body portion 121 via the arm portion 122 toward the user's eyes via the lens 129 of the glasses 128. The technology according to the above embodiment and the like can be applied to such a head mounted display 120.

Note that the head mounted display 120 is a so-called light guide plate type head mounted display, but is not limited thereto, and may be, for example, a so-called bird bus type head mounted display. The bird bus type head mounted display includes, for example, a beam splitter and a partially transparent mirror. The beam splitter outputs light encoded with the image information toward the mirror, and the mirror reflects the light toward the user's eyes. Both the beam splitter and the partially transparent mirror are partially transparent.

As a result, light from the surrounding environment reaches the eyes of the user.

### Application Example 3

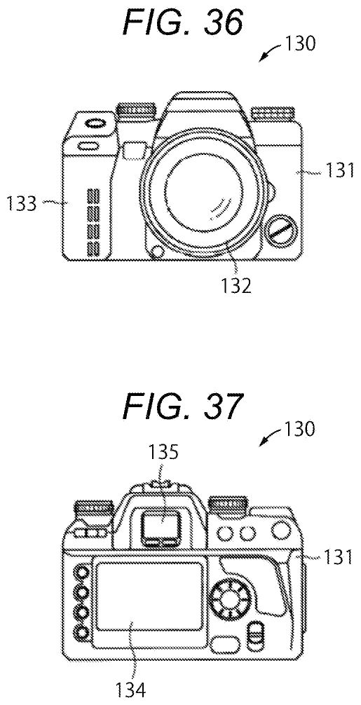

FIGS. 36 and 37 illustrate an example of an external appearance of a digital still camera 130, FIG. 36 illustrates a front view, and FIG. 37 illustrates a rear view. The digital still camera 130 is a lens interchangeable single-lens reflex type camera, and includes a camera main body portion (camera body) 131, an imaging lens unit 132, a grip portion 133, a monitor 134, and an electronic viewfinder 135. The imaging lens unit 312 is an interchangeable lens unit, and is provided near substantially the center of the front surface of the camera main body portion 311. The grip portion 133 is provided on the left side of the front surface of the camera main body portion 311, and the photographer grips the grip portion 133. The monitor 134 is provided on the left side of substantially the center of the back surface of the camera main body portion 131. The electronic viewfinder 135 is provided on the upper part of the monitor 14 on the back surface of the camera main body portion 131. By looking into the electronic viewfinder 135, the photographer can visually recognize the optical image of the subject guided from the imaging lens unit 132 and determine the composition. The technology according to the above embodiment and the like can be applied to the electronic viewfinder 135.

### Application Example 4

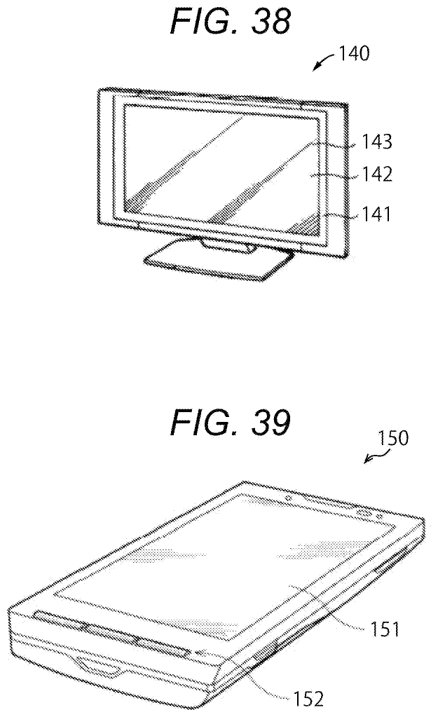

FIG. 38 illustrates an example of an external appearance of a television device 140. The television device 140 includes a video display screen unit 141 including a front panel 142 and a filter glass 143. The technology according to the above embodiment and the like can be applied to the video display screen unit 141.

### Application Example 5

FIG. 39 illustrates an example of an external appearance of a smartphone 150. The smartphone 150 includes a display unit 151 that displays various types of information, and an operation unit 152 including a button or the like that receives an operation input by the user. The technology according to the above embodiment and the like can be applied to the display unit 151.

### Application Example 6

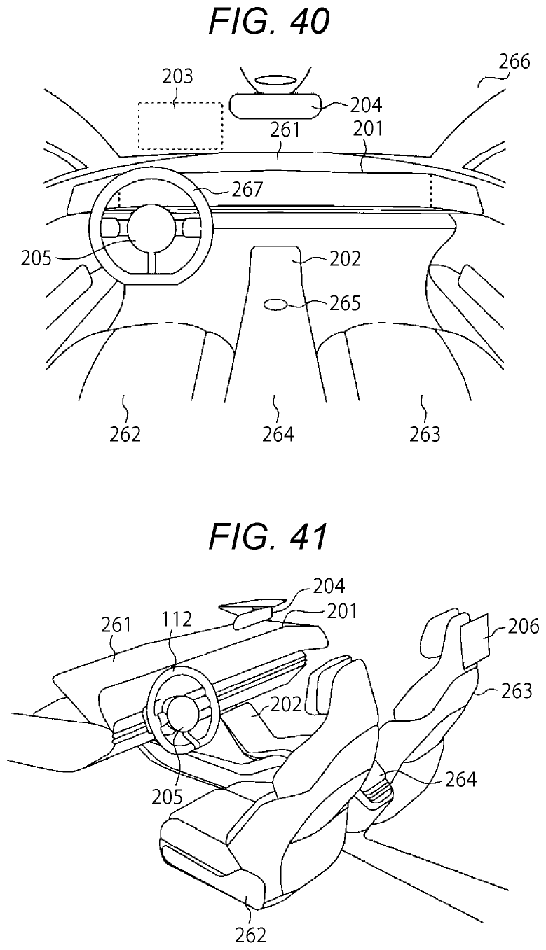

FIGS. 40 and 41 illustrate a configuration example of a vehicle to which the technology of the present disclosure is applied, FIG. 40 illustrates an example of the inside of the vehicle as viewed from the rear of the vehicle 200, and FIG. 41 illustrates an example of the inside of the vehicle as viewed from the left rear of the vehicle 200.

The vehicle of FIGS. 40 and 41 includes a center display 201, a console display 202, a head-up display 203, a digital rear mirror 204, a steering wheel display 205, and a rear entertainment display 106.

The center display 201 is disposed on a dashboard 261 at a position facing a driver's seat 262 and a passenger seat 263. FIG. 40 illustrates an example of the center display 201 having a horizontally long shape extending from the driver's seat 262 side to the passenger seat 263 side, but the screen size and the arrangement location of the center display 201 are not limited thereto. The center display 201 can display information detected by various sensors. As a specific example, the center display 201 can display a captured image captured by the image sensor, a distance image to an obstacle in front of or on a side of the vehicle measured by the ToF sensor, a body temperature of the occupant detected by the infrared sensor, and the like. The center display 201 can be used to display, for example, at least one of safety-related information, operation-related information, a life log, health-related information, authentication/identification-related information, or entertainment-related information.

The safety-related information is information such as doze detection, looking-away detection, mischief detection of a child riding together, presence or absence of wearing a seat belt, and detection of leaving of an occupant based on a detection result of the sensor. The operation-related information is gesture information regarding the operation of the occupant detected using the sensor. The gesture may include operations of various facilities in the vehicle, for example, operations of an air conditioning equipment, a navigation device, an audio visual (AV) device, a lighting device, and the like. The life log includes life logs of all the occupants. For example, the life log includes an action record of each occupant. By acquiring and storing the life log, it is possible to confirm the state of the occupant when the accident occurs. The health-related information includes the body temperature of the occupant detected using the temperature sensor and information on the health condition of the occupant estimated on the basis of the detected body temperature. Alternatively, the information on the health condition of the occupant may be estimated on the basis of the face of the occupant captured by the image sensor. Furthermore, the information on the health condition of the occupant may be estimated on the basis of an answer content of the occupant obtained by talking with the occupant using the automatic voice. The authentication/identification-related information includes information such as a keyless entry function for performing face authentication using a sensor and an automatic adjustment function of a seat height and a position in face identification. The entertainment-related information includes operation information of the AV device by the occupant detected by the sensor, information of content suitable for the occupant detected and recognized by the sensor, and the like.

The console display 202 can be used to display the life log information, for example. The console display 202 is disposed near the shift lever 265 in the center console 264 between the driver's seat 262 and the passenger seat 263. The console display 202 can also display information detected by various sensors. Furthermore, the console display 202 may display an image of the periphery of the vehicle captured by the image sensor, or may display a distance image to an obstacle in the periphery of the vehicle.

The head-up display 203 is virtually displayed behind a windshield 266 in front of the driver's seat 262. The head-up display 203 can be used to display, for example, at least one of the safety-related information, the operation-related information, the life log, the health-related information, the authentication/identification-related information, or the entertainment-related information. Since the head-up display 203 is often virtually arranged in front of the driver's seat 262, it is suitable for displaying information directly related to the operation of the vehicle, such as the speed of the vehicle, the remaining amount of fuel, and the remaining amount of the battery.

The digital rear mirror 204 can display not only the rear of the vehicle but also the state of the occupant in the rear seat, and thus can be used to display the life log information of the occupant in the rear seat, for example.

The steering wheel display 205 is disposed near the center of a steering wheel 267 of the vehicle. The steering wheel display 205 can be used to display, for example, at least one of the safety-related information, the operation-related information, the life log, the health-related information, the authentication/identification-related information, or the entertainment-related information. In particular, because the steering wheel display 205 is close to the driver's hand, the steering wheel display 205 is suitable for displaying the life log information such as a body temperature of the driver, or for displaying information regarding an operation of the AV device, air conditioning equipment, or the like.

The rear entertainment display 206 is attached to the back side of the driver's seat 262 and the passenger seat 263, and is for viewing by an occupant in the rear seat. The rear entertainment display 206 can be used to display, for example, at least one of the safety-related information, the operation-related information, the life log, the health-related information, the authentication/identification-related information, or the entertainment-related information. In particular, because the rear entertainment display 206 is in front of the occupant in the rear seat, information related to the occupant in the rear seat is displayed. The rear entertainment display 206 may display, for example, information regarding the operation of an AV device or an air conditioning equipment, or may display a result of measuring the body temperature or the like of the occupant in the rear seat by the temperature sensor 5.

The technology according to the above embodiment and the like can be applied to the center display 201, the console display 202, the head-up display 203, the digital rear mirror 204, the steering wheel display 205, and the rear entertainment display 206.

Note that the present technology can have the following configurations.
(1) A display device including:
a plurality of pixel circuits arranged in at least one direction;
a plurality of signal lines that supplies a signal voltage corresponding to gradation to the plurality of pixel circuits;
an error amplifier that outputs an instruction signal corresponding to a difference between a first ramp wave voltage whose voltage level changes with time and a second ramp wave voltage that is a predetermined potential of a ramp wiring;
an output unit that outputs the second ramp wave voltage based on the first ramp wave voltage to the ramp wiring in response to the instruction signal;
a plurality of voltage holding units that holds the second ramp wave voltage and generates the signal voltage at a timing according to luminance of the plurality of pixel circuits by switches connected between the ramp wiring and the plurality of signal lines;
a plurality of correction current sources that supplies a correction current to a plurality of connection paths between the ramp wiring and the plurality of voltage holding units; and
a current adjustment unit that adjusts the correction current on the basis of the instruction signal.
(2) The display device according to (1), in which, when the second ramp wave voltage is supplied to the ramp wiring, the plurality of correction current sources supplies the correction current being same to the plurality of connection paths regardless of luminance set to the plurality of pixel circuits.
(3) The display device according to (1) or (2), in which the current adjustment unit adjusts the correction current such that the instruction signal in a case where the correction current flows from the plurality of correction current sources to the plurality of connection paths coincides with the instruction signal in a case where the correction current does not flow.
(4) The display device according to (1), in which the current adjustment unit adjusts the correction current on the basis of a difference between a first instruction signal output from the error amplifier in a case where the plurality of connection paths is in a first state and a second instruction signal output from the error amplifier in a case where the plurality of connection paths is in a second state different from the first state.
(5) The display device according to (4), in which the current adjustment unit adjusts the correction current such that a voltage based on the first instruction signal matches a voltage based on the second instruction signal.
(6) The display device according to (5), in which a voltage based on the first instruction signal and a voltage based on the second instruction signal are correlated with a current value flowing through a predetermined portion of the ramp wiring in the first state and a current value flowing through a predetermined portion of the ramp wiring in the second state.
(7) The display device according to (4), in which the plurality of pixel circuits in the first state is in a white gradation writing state, and the plurality of pixel circuits in the second state is in a black gradation writing state.
(8) The display device according to (4), in which the first instruction signal is the instruction signal in a case where the correction current flows from the plurality of correction current sources to the plurality of connection paths, and the second instruction signal is the instruction signal in a case where the correction current does not flow.
(9) The display device according to (4), in which the current adjustment unit performs processing of making the correction current larger in a case where a voltage based on the second instruction signal is lower than a voltage based on the first instruction signal, and making the correction current smaller in a case where the voltage based on the second instruction signal is higher than the voltage based on the first instruction signal.
(10) The display device according to (4), in which the current adjustment unit includes:
a voltage comparator that outputs a signal corresponding to a voltage difference between a voltage based on the first instruction signal and a voltage based on the second instruction signal; and
an adjustment signal generation unit that generates an adjustment signal of a plurality of bits for the current adjustment unit to adjust the correction current on the basis of the signal output from the voltage comparator, and
the current adjustment unit adjusts the correction current on the basis of the adjustment signal.
(11) The display device according to (10), in which the adjustment signal generation unit adjusts the adjustment signal by one bit each time the correction current is adjusted.
(12) The display device according to (11), in which the current adjustment unit further includes
a current-voltage conversion unit that converts a voltage into the voltage based on the first instruction signal and the voltage based on the second instruction signal.
(13) The display device according to (11), in which the voltage based on the first instruction signal and the voltage based on the second instruction signal are correlated with a current value flowing through a predetermined portion of the ramp wiring.
(14) The display device according to (12), in which the voltage comparator is any of a successive approximation type analog-to-digital converter, a pipeline analog-to-digital converter, a comparator, and an error amplifier.
(15) The display device according to (14), in which the current adjustment unit further includes a bias circuit that generates a bias potential according to the adjustment signal and supplies the bias potential to the correction current source, and
the correction current source outputs the correction current according to the bias potential.
(16) The display device according to (15), in which the bias circuit includes a capacitor.
(17) The display device according to (4), in which the current adjustment unit includes:
a voltage comparator that outputs a signal corresponding to a voltage difference between a voltage based on the first instruction signal and a voltage based on the second instruction signal;
a phase comparator that outputs a signal corresponding to a phase difference between the signal output from the voltage comparator and a predetermined reference signal; and
a charge pump that outputs a voltage corresponding to a signal output from the phase comparator, and
the current adjustment unit adjusts the correction current on the basis of a voltage output from the charge pump.
(18) The display device according to (1), in which the output unit outputs an offset voltage for correcting characteristic variations of the plurality of pixel circuits to the ramp wiring before outputting the second ramp wave voltage to the ramp wiring, and
the current adjustment unit adjusts the correction current supplied from the plurality of correction current sources to the plurality of connection paths on the basis of a difference between the instruction signals when outputting the second ramp wave voltage.
(19) The display device according to (1), in which the current adjustment unit adjusts the correction current a plurality of times, one time each in accordance with horizontal line scanning, within a blanking period between two consecutive frames.
(20) The display device according to (1), in which the voltage level of the first ramp wave voltage fluctuates linearly with time.
(21) The display device according to (4), in which the plurality of pixel circuits in the first state is in a reference voltage writing state, and the plurality of pixel circuits in the second state is in a black gradation writing state.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions are possible without departing from the conceptual idea and spirit of the present disclosure derived from the contents defined in the claims and equivalents thereof.

### REFERENCE SIGNS LIST

1 Display device
2 Display system
11 Pixel array unit
13 H-DRV unit
51 Ramp buffer
55 Ramp wiring
56 Voltage holding unit
56a Switch
57 Level shifter
58 Correction current source
59 Comparator
60 Current adjustment unit
61 Switch
510 Differential stage (error amplifier)
512 Output unit
600, 600a, 600b Current-voltage conversion unit
610, 660, 662 Voltage comparator
620 Adjustment signal generation unit
630, 630a Bias circuit
645 Amplification unit
690 Charge pump
700 Cascode current mirror circuit

1. A display device comprising:
a plurality of pixel circuits arranged in at least one direction;
a plurality of signal lines that supplies a signal voltage corresponding to gradation to the plurality of pixel circuits;
an error amplifier that outputs an instruction signal corresponding to a difference between a first ramp wave voltage whose voltage level changes with time and a second ramp wave voltage that is a predetermined potential of a ramp wiring;
an output unit that outputs the second ramp wave voltage based on the first ramp wave voltage to the ramp wiring in response to the instruction signal;
a plurality of voltage holding units that holds the second ramp wave voltage and generates the signal voltage at a timing according to luminance of the plurality of pixel circuits by switches connected between the ramp wiring and the plurality of signal lines;
a plurality of correction current sources that supplies a correction current to a plurality of connection paths between the ramp wiring and the plurality of voltage holding units; and
a current adjustment unit that adjusts the correction current on a basis of the instruction signal.

2. The display device according to claim 1, wherein, when the second ramp wave voltage is supplied to the ramp wiring, the plurality of correction current sources supplies the correction current being same to the plurality of connection paths regardless of luminance set to the plurality of pixel circuits.

3. The display device according to claim 1, wherein the current adjustment unit adjusts the correction current such that the instruction signal in a case where the correction current flows from the plurality of correction current sources to the plurality of connection paths coincides with the instruction signal in a case where the correction current does not flow.

4. The display device according to claim 1, wherein the current adjustment unit adjusts the correction current on a basis of a difference between a first instruction signal output from the error amplifier in a case where the plurality of connection paths is in a first state and a second instruction signal output from the error amplifier in a case where the plurality of connection paths is in a second state different from the first state.

5. The display device according to claim 4, wherein the current adjustment unit adjusts the correction current such that a voltage based on the first instruction signal matches a voltage based on the second instruction signal.

6. The display device according to claim 5, wherein a voltage based on the first instruction signal and a voltage based on the second instruction signal are correlated with a current value flowing through a predetermined portion of the ramp wiring in the first state and a current value flowing through a predetermined portion of the ramp wiring in the second state.

7. The display device according to claim 4, wherein the plurality of pixel circuits in the first state is in a white gradation writing state, and the plurality of pixel circuits in the second state is in a black gradation writing state.

8. The display device according to claim 4, wherein the first instruction signal is the instruction signal in a case where the correction current flows from the plurality of correction current sources to the plurality of connection paths, and the second instruction signal is the instruction signal in a case where the correction current does not flow.

9. The display device according to claim 4, wherein the current adjustment unit performs processing of making the correction current larger in a case where a voltage based on the second instruction signal is lower than a voltage based on the first instruction signal, and making the correction current smaller in a case where the voltage based on the second instruction signal is higher than the voltage based on the first instruction signal.

10. The display device according to claim 4, wherein the current adjustment unit includes:
a voltage comparator that outputs a signal corresponding to a voltage difference between a voltage based on the first instruction signal and a voltage based on the second instruction signal; and
an adjustment signal generation unit that generates an adjustment signal of a plurality of bits for the current adjustment unit to adjust the correction current on a basis of the signal output from the voltage comparator, and
the current adjustment unit adjusts the correction current on a basis of the adjustment signal.

11. The display device according to claim 10, wherein the adjustment signal generation unit adjusts the adjustment signal by one bit each time the correction current is adjusted.

12. The display device according to claim 11, wherein the current adjustment unit further includes
a current-voltage conversion unit that converts a voltage into the voltage based on the first instruction signal and the voltage based on the second instruction signal.

13. The display device according to claim 11, wherein the voltage based on the first instruction signal and the voltage based on the second instruction signal are correlated with a current value flowing through a predetermined portion of the ramp wiring.

14. The display device according to claim 12, wherein the voltage comparator is any of a successive approximation type analog-to-digital converter, a pipeline analog-to-digital converter, a comparator, and an error amplifier.

15. The display device according to claim 14, wherein the current adjustment unit further includes a bias circuit that generates a bias potential according to the adjustment signal and supplies the bias potential to the correction current source, and
the correction current source outputs the correction current according to the bias potential.

16. The display device according to claim 15, wherein the bias circuit includes a capacitor.

17. The display device according to claim 4, wherein the current adjustment unit includes:
a voltage comparator that outputs a signal corresponding to a voltage difference between a voltage based on the first instruction signal and a voltage based on the second instruction signal;
a phase comparator that outputs a signal corresponding to a phase difference between the signal output from the voltage comparator and a predetermined reference signal; and
a charge pump that outputs a voltage corresponding to a signal output from the phase comparator, and
the current adjustment unit adjusts the correction current on a basis of a voltage output from the charge pump.

18. The display device according to claim 1, wherein the output unit outputs an offset voltage for correcting characteristic variations of the plurality of pixel circuits to the ramp wiring before outputting the second ramp wave voltage to the ramp wiring, and
the current adjustment unit adjusts the correction current supplied from the plurality of correction current sources to the plurality of connection paths on a basis of a difference between the instruction signals when outputting the second ramp wave voltage.

19. The display device according to claim 1, wherein the current adjustment unit adjusts the correction current a plurality of times, one time each in accordance with horizontal line scanning, within a blanking period between two consecutive frames.

20. The display device according to claim 1, wherein the voltage level of the first ramp wave voltage fluctuates linearly with time.

21. The display device according to claim 4, wherein the plurality of pixel circuits in the first state is in a reference voltage writing state, and the plurality of pixel circuits in the second state is in a black gradation writing state.
